(19) United States
(12) Patent Application Publication
(10) Pub. No.: US 2026/0181569 A1
(43) Pub. Date: Jun. 25, 2026

(54) METHODS, ARCHITECTURES, APPARATUSES AND SYSTEMS TO SUPPORT BEAM POWER DOMAIN ADAPTATION

(71) Applicant: InterDigital Patent Holdings, Inc., Wilmington, DE (US)

(72) Inventors: Jaya Rao, Montreal (CA); Tao Deng, New York, NY (US); Faris Alfarhan, Montreal (CA); Moon IL Lee, Melville, NY (US); Paul Marinier, Brossard (CA); Umer Salim, Vallauris (FR)

(21) Appl. No.: 18/989,644

(22) Filed: Dec. 20, 2024

(51) Int. Cl. H04W 56/00; H04B 17/318; H04W 52/24; H04W 72/231

(52) U.S. Cl. CPC H04W 56/0015; H04B 17/328; H04W 52/242; H04W 72/231

(57) ABSTRACT

A wireless transmit/receive unit (WTRU) may be configured to detect a cell based on reception of one or more synchronization signal/physical broadcast channel blocks (SSBs). The WTRU may receive a payload from the one or more SSBs. The payload may include information indicating a first set of SSB parameters. The WTRU may receive a physical downlink control channel transmission including information indicating a second set of SSB parameters. The WTRU may determine a set of SSB bursts based on the first set of SSB parameters, the second set of SSB parameters, and time domain locations of SSBs of the set of SSB bursts. The WTRU may measure one or more SSBs in the determined set of SSB bursts. The WTRU may send, to the cell, an indication using a transmit power and/or a beam that is associated with an SSB of the measured one or more SSBs.

### BACKGROUND

The present application is related to the fields of communications, software and encoding, including, for example, to methods, architectures, apparatuses, systems directed to network energy savings and/or wireless transmit/receive unit (WTRU) energy savings.

In current 5G standards, the network may be enabled to minimize its energy consumption due to transmissions and receptions. For example, network energy savings (NES) capabilities may include performing adaptations in multiple domains including in the spatial domain (e.g., powering off subsets of antenna ports, elements or panels), the time domain (e.g., applying cell discontinuous transmission (DTX) and discontinuous reception (DRX), or applying a long periodicity for synchronization signal block (SSB) transmissions), the frequency domain (e.g., disabling certain carriers or bandwidth parts (BWPs)), or the power domain (e.g., applying lower power offset values).

While the NES enhancements supported in 5G Releases 18 and 19 were specified with the assumption that the network is lightly or moderately loaded in terms of achievable throughput by the WTRUs in cells, future releases or generations are expected to support more advanced capabilities and features for NES even in high load scenarios. In high load scenarios, the network is assumed to be active most of the time, where the transmissions and receptions may be performed when the load level is at least 75%, for example. Both downlink (DL) and uplink (UL) traffic are expected to have a high degree of dynamism. For improving NES gains in high load scenarios, the network nodes are expected to quickly transition to an NES mode after using high load capabilities (e.g., a high number of antenna elements/ports, multiple transmission layers, and/or carriers). There is a need for faster and more efficient adaptation at the network, such as for power levels applied for common signals and/or channels, such as SSB, primary synchronization signal (PSS), secondary synchronization signal (SSS), physical broadcast channel (PBCH), and/or channel state information reference signals (CSI-RS), to enable the network nodes to operate in low power and/or NES modes as much as possible.

### BRIEF SUMMARY

Briefly stated, in one embodiment, one or more of a SSB and/or a RS may be determined during transmission power adaptation. For example, a WTRU may be configured with parameters associated with SSB and/or RS beam power adaptation. The WTRU may receive one or more indications associated with SSB and/or RS beam power adaptation. Information associated with SSB and/or RS power adaptation may be included in the received indications. The WTRU may determine one or more actions and/or behaviors upon receiving the indications, such as may be associated with SSB power patterns).

In one embodiment, radio link management (RLM) and/or beam management (BM) may be enabled during SSB and/or RS transmission power adaptation. For example, a WTRU may be configured with a set of SSB and/or RS beams and/or parameters associated with RLM and/or BM. The WTRU may perform a radio link failure detection procedure during SSB and/or RS power adaptation. The WTRU may perform a radio link recovery procedure during SSB and/or RS power adaptation.

In one embodiment, a WTRU may be configured to detect a cell based on reception of one or more SSBs. The WTRU may receive a master information block (MIB) from the one or more SSBs. The MIB may include information indicating a first set of SSB parameters. For example, the first set of SSB parameters may include a peak transmit power of a reference SSB. The WTRU may receive a physical downlink control channel (PDCCH) transmission including information indicating a second set of SSB parameters. The WTRU may determine a set of SSB bursts based on the first set of SSB parameters, the second set of SSB parameters, and time domain locations of SSBs of the set of SSB bursts. The WTRU may measure one or more SSBs in the determined set of SSB bursts. The WTRU may send, the cell, an indication (e.g., a PRACH transmission) using a transmit power and/or a beam that is associated with an SSB of the measured one or more SSBs.

In one embodiment, a WTRU may receive information indicating a set of parameters associated with SSB transmit power adaptation. The WTRU may receive one or more indications associated with the SSB transmit power adaptation. The WTRU may determine a SSB power pattern for a set of SSB bursts associated with the SSB transmit power adaptation. The WTRU may measure one or more SSBs in the determined set of SSB bursts. The WTRU may send a transmission based on measurement information associated with the measured one or more SSBs satisfying one or more conditions.

In one embodiment, a WTRU may receive information indicating a set of parameters associated with RS transmit power adaptation. The WTRU may receive one or more indications associated with the RS transmit power adaptation. The WTRU may determine a RS power pattern for a set of RSs associated with the RS transmit power adaptation. The WTRU may measure one or more RSs in the determined set of RSs. The WTRU may send a transmission based on measurement information associated with the measured one or more RSs satisfying one or more conditions.

In one embodiment, a WTRU may be configured to receive information indicating a set of parameters associated with a set of SSB beams for radio link monitoring. The WTRU may receive one or more indications associated with the SSB transmit power adaptation. The WTRU may determine a first target set of SSB beams based on the set of SSB beams for radio link monitoring as a source set. For example, the first target set of SSB beams may be associated with the SSB transmit power adaptation. The WTRU may measure one or more SSBs in the determined first target set of SSB beams. The WTRU may determine a radio link failure event based on measurement information associated with the set of SSB beams for radio link monitoring and/or measurement information associated with the determined first target set of SSB beams. The WTRU may determine, based on the radio link failure event, a second target set of SSB beams. The WTRU may send information indicating any of: (i) the radio link failure event, (ii) the measurement information associated with the determined first target set of SSB beams, and/or (iii) one or more identifiers of the second target set of SSB beams.

In one embodiment, a WTRU may be configured to receive information indicating a set of parameters associated with a set of RS beams for radio link monitoring. The WTRU may receive one or more indications associated with the RS transmit power adaptation. The WTRU may determine a first target set of RS beams based on the set of SSRSB beams for radio link monitoring as a source set. For example, the first target set of RSSSB beams may be associated with the RS transmit power adaptation. The WTRU may measure one or more RSs in the determined first target set of RS beams. The WTRU may determine a radio link failure event based on measurement information associated with the set of RS beams for radio link monitoring and/or measurement information associated with the determined first target set of RS beams. The WTRU may determine, based on the radio link failure event, a second target set of RS beams. The WTRU may send information indicating any of: (i) the radio link failure event, (ii) the measurement information associated with the determined first target set of RS beams, and/or (iii) one or more identifiers of the second target set of RS beams.

Other embodiments are described in detail herein.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system, according to one or more embodiments of the present disclosure;

FIG. 1B is a system diagram illustrating an example wireless transmit/receive unit (WTRU) that may be used within the communications system illustrated in FIG. 1A, according to one or more embodiments of the present disclosure;

FIG. 1C is a system diagram illustrating an example radio access network (RAN) and an example core network (CN) that may be used within the communications system illustrated in FIG. 1A, according to one or more embodiments of the present disclosure;

FIG. 1D is a system diagram illustrating a further example RAN and a further example CN that may be used within the communications system illustrated in FIG. 1A, according to one or more embodiments of the present disclosure;

FIG. 2 is a timing and power diagram illustrating an example of legacy transmission of SSBs;

FIG. 3 is a timing and power diagram illustrating an example of transmission of SSBs according to one or more embodiments of the present disclosure;

FIG. 4 is a timing and power diagram illustrating examples of SSB power patterns, according to one or more embodiments of the present disclosure;

FIG. 5 is a timing and power diagram illustrating examples of measurement thresholds for an example SSB burst, according to one or more embodiments of the present disclosure;

FIG. 6 is a procedural diagram illustrating an example procedure for determining SSBs during transmit power adaptation, according to one or more embodiments of the present disclosure;

FIG. 7 is a procedural diagram illustrating an example procedure for determining a SSB power pattern, according to one or more embodiments of the present disclosure;

FIG. 8 is a procedural diagram illustrating an example procedure for determining a RS power pattern, according to one or more embodiments of the present disclosure;

FIG. 9 is a procedural diagram illustrating an example procedure for radio link management during SSB transmit power adaptation, according to one or more embodiments of the present disclosure; and

FIG. 10 is a procedural diagram illustrating an example procedure for radio link management during RS transmit power adaptation, according to one or more embodiments of the present disclosure.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc, and/or any portion thereof, it is to be understood that any embodiments described and/or claimed herein assume that any apparatus, system, device, etc, and/or any element thereof is configured to carry out any operation, process, algorithm, function, etc, and/or any portion thereof.

### Example Communications System

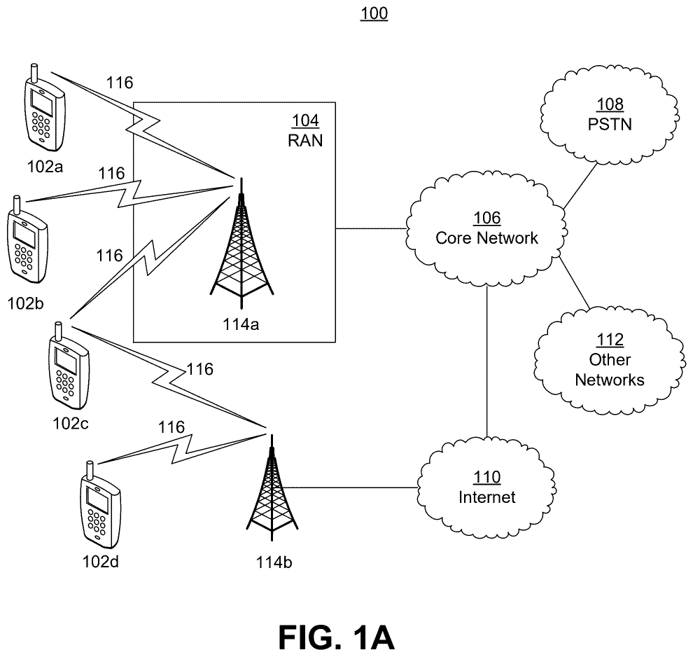

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

In certain representative embodiments, one or more assumptions may be made regarding NES mode operation at the network. For example, a cell may dynamically adapt the transmission power of at least a subset of RS beams (e.g., SSBs) in a burst, such as during low load conditions and/or for providing coverage only in certain directions. For example, given a set of 4 SSB beams in a burst {SSB #0, SSB #1, SSB #2, SSB #3}, the network may reduce the transmit power of SSB #0, SSB #1, and SSB #3 by 5 dB, 10 dB, 15 dB respectively, while retaining the transmit power of SSB #2 at 21 dBm (e.g., without power reduction). For example, SSB #0 may be (e.g., alternatively) transmitted with peak power only in certain periods, such as over a longer periodicity (e.g., 80 ms or 160 ms). For example, when an SSB in a burst is transmitted without power adaptation (e.g., transmitted with peak power), it may be used as a reference beam based on which the parameters (e.g., power offset) of other SSBs may be derived.

In certain representative embodiments, one or more assumptions may be made regarding WTRU operation. For example, a WTRU (e.g., in CONNECTED or IDLE mode) may be configured, or otherwise indicated, with parameters related to SSB transmit power patterns for determining the SSBs (e.g., for L1/L3 measurements), and for supporting other associated procedures (e.g., cell selection, path loss (PL) estimation, physical random access channel (PRACH) transmission, and/or beam management).

In certain representative embodiments, a WTRU may (e.g., be expected to) determine an association between the power offsets and timing of the SSB beams, such as upon receiving an indication from the network on the SSB power adaptation.

In certain representative embodiments, a WTRU may select a (e.g., best) SSB from among a set of active SSB beams (e.g., for PL estimation, PRACH transmission) that are transmitted with different power levels and/or different burst periods.

In certain representative embodiments, dynamic adaptation of the transmit power of RS beams (e.g. SSBs) may be performed in consideration of significant impacts on other connectivity and radio link management procedures (e.g., PL estimation, beam selection, RACH).

In certain representative embodiments, dynamic adaptation of the transmit power may be performed from the legacy approach using an existing equal power level for all active SSB beams to different and/or uneven power levels that may be optimized for NES and coverage such that the impact to other associated procedures is minimal.

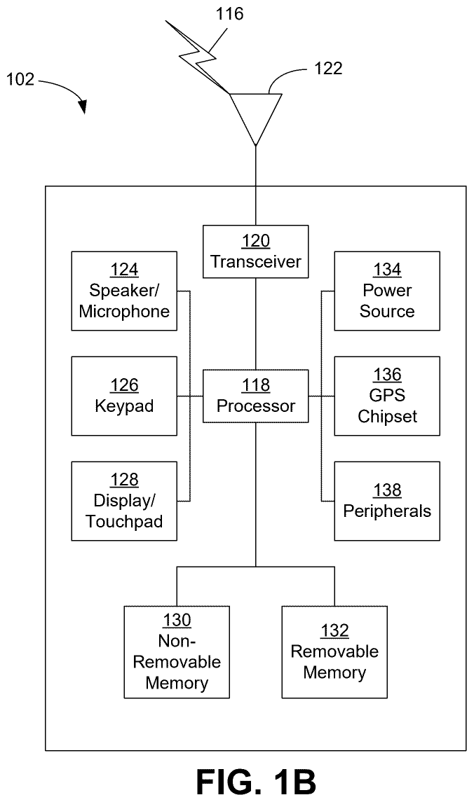

FIG. 2 is a timing and power diagram illustrating an example of legacy transmission of SSBs. In legacy 5G, the transmit power of SSBs is configured to be equal for all active SSBs in a burst during beam sweeping. The SSB parameters (e.g., SSB positions in burst, SSB periodicity, SSB power) are provided in SIB1, which is typically transmitted with a long periodicity (e.g., 160 ms).

In Release 18 NES, the enhancements specified (e.g., cell DTX/DRX operation, CSI-RS framework for spatial and power domain adaptations) do not impact the transmission of DL common signals such as SSBs. The SSBs are transmitted based on semi-statically configured parameters to avoid any impacts to legacy 5G WTRUs.

In Release 19 NES, the adaptations to SSBs considered are related to adapting the periodicity of SSB transmission. Such adaptations are also designed to be done semi-statically and with the aim of avoiding any impacts to legacy WTRUs. Further, such adaptation is collective for all SSBs in an SSB configuration (e.g., all are ON or all are muted).

For realizing high NES gains, it may be beneficial for the DL RSs (e.g., always-on SSBs) to be transmitted with reduced power levels. For example, a subset of SSBs in a burst may be transmitted with lower power compared to other SSBs or may be transmitted with peak power only in some periods.

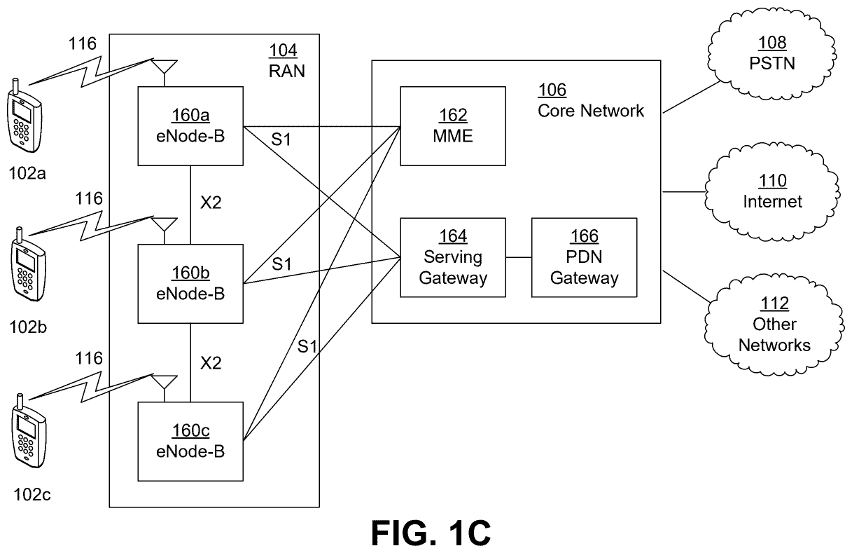

FIG. 3 is a timing and power diagram illustrating an example of transmission of SSBs according to one or more embodiments of the present disclosure. As shown in FIG. 3, a power offset may refer to the power level of one or more SSBs in a burst relative to a peak power used in the burst. For example, one or more power offsets may be used for a given SSB burst and/or transmit power pattern. For example, a peak power period may refer to the periodicity of the transmission of an SSB having a peak power level (e.g., SSB burst with a same transmit power pattern).

In next generation systems, such as 6G, the transmit power of DL RSs may be adapted more dynamically (e.g., per beam, per burst, per cell) and/or gradually for realizing greater NES gains without the restriction of avoiding legacy WTRU impacts.

In certain representative embodiments, procedures for adapting the transmit power of SSBs (e.g., at the per beam level) may be performed in consideration of the impact on other associated procedures (e.g., PRACH transmission).

In certain representative embodiments, procedures for determining the SSB bursts (e.g., for measurements) may be performed in consideration of transmit power adaptation of SSBs (e.g., at the per beam level).

In certain representative embodiments, a WTRU 102 may determine a per-beam transmit power level and timing information of SSB bursts (e.g., for measurements and/or best beam selection for PRACH transmission) based on semi-static and/or dynamic indications received on the SSB parameters.

In certain representative embodiments, a WTRU may detect a cell based on the reception of at least one SSB. For example, cell detection may include performing timing and/or frequency synchronization based on a received PSS and/or SSS associated with SSB.

In certain representative embodiments, a WTRU may receive an indication of (e.g., semi-static) SSB parameters in a PBCH payload, such as a master information block (MIB). For example, a (e.g., semi-static) SSB parameter may include at least the peak SSB power (e.g., transmit power of a reference SSB). For example, other semi-static SSB parameters may include any of SSB time domain location parameters (e.g., SFN index, half-frame index, SSB burst periodicity) and SSB positions in a burst. For example, a MIB may include information indicating control resource set(s) (CORESET(s)) and/or search space(s) (SSs) for receiving a physical downlink control channel (PDCCH) (e.g., a multiplexing pattern).

In certain representative embodiments, a WTRU may receive an indication of (e.g., dynamic) SSB parameters (e.g., in PDCCH). For example, one or more (e.g., dynamic) SSB parameters may be received in a group common DCI in a CORESET and/or SS indicated by a MIB. For example, dynamic SSB parameters may include any of SSB power pattern (e.g., index thereof), a start offset of the power pattern, a periodicity of the power pattern, and/or a power offset per SSB. For example, other dynamic parameters may include a reference SSB per burst and/or a RSRP threshold per SSB.

In certain representative embodiments, a WTRU may determine one or more SSB bursts (e.g., for measurements) based on the transmit power of SSBs and the association between the transmit power and time domain locations of the SSBs. For example, a WTRU 102 may determine the transmit power of each active SSB in a burst based on the peak SSB power and power offset per SSB parameters. For example, a WTRU 102 may determine the association between the transmit power and time domain locations of SSBs based on SSB power pattern parameters (e.g., the index of SSB power pattern, the start offset of pattern, and/or the periodicity of pattern) and/or SSB time domain location parameters (e.g., SFN index, half-frame index, and/or SSB burst periodicity). For example, a WTRU 102 may determine a subset of SSB bursts from a set (e.g., in a period) for measurements when (e.g., only) some target SSB(s) within a burst are transmitted with peak power.

In certain representative embodiments, a WTRU may perform measurements of the SSBs in one or more of the determined bursts.

In certain representative embodiments, a WTRU may determine a SSB, such as a best SSB, among the measured SSBs based on the received parameters and measurements. For example, a WTRU 102 may determine the best SSB from the measured SSBs with an RSRP that is above an RSRP threshold per SSB. If the RSRP of all SSBs are below their thresholds, the WTRU 102 may determine the best SSB from the SSB with the lowest pathloss estimation. For example, the criteria for beam ranking and selecting the best SSB among the measured SSBs may be based on a combination of RSRP measurements and pathloss estimation.

In certain representative embodiments, a WTRU may send a PRACH transmission with (e.g., using) a transmit power in a beam that is associated with the best SSB. For example, the WTRU 102 may determine the transmit power for PRACH based on the pathloss estimation made on the best SSB.

In certain representative embodiments, the network may flexibly adapt the transmit power of SSB beams for energy savings.

In certain representative embodiments, low latency signaling of SSB parameters (e.g., peak power) may be supported in PDCCH transmissions (e.g., DCI).

In certain representative embodiments, low complexity procedures may be supported at a WTRU 102 for SSB measurements and beam selection (e.g., for PRACH transmission).

The following terminology and acronyms may be used throughout the disclosure.

A “Synchronization Signal Block” (SSB) or SS/PBCH block may include or refer to at least one of the following: a PSS (Primary Synchronization Signal), a SSS (Secondary Synchronization Signal), a Physical Broadcast Channel (PBCH), a Master information block (MIB), PBCH DMRS(s) and a PBCH payload. The SSBs may be transmitted by and/or received from a network node (e.g., base station, transmission/reception point (TRP), relay node, or reconfigurable intelligent surface (RIS) unit) in different directions as beams. The number of SSB beams in an SSB burst set, which may be transmitted periodically within an interval (e.g., 5 ms, 20 ms) may depend on the carrier frequency. For example, an SSB burst may contain 4 SSBs for FR1 (<3 GHz), 8 SSBs for FR1 (3 to 6 GHz) and 64 SSBs for FR2. Certain SSBs may be transmitted as on-demand SSBs (OD-SSBs), which may include a subset of SSBs in a burst. Such OD-SSBs may be transmitted aperiodically, semi-persistently, or periodically with certain periodicity. The transmission of such OD-SSBs may be triggered by the network node or WTRU 102 (e.g., via transmission of an UL wake-up signal (WUS)). Some SSBs may include slim or lean SSBs, which may comprise of PSS only, PSS and SSS-only, PBCH-payload only, MIB-only or a subset of MIB-only, for example.

A “channel state information reference signal” (CSI-RS) may include or refer to at least one of the following: a CSI-RS resource set (ID), a CSI-RS resource (ID/index), a resource mapping, power control offset values (e.g., with respect to PDSCH, SSB), a scrambling ID, a periodicity, an offset and QCL information. A CSI-RS may be transmitted in the DL by the network node as CSI-RS beams, such as via different resource types including periodic, semi-persistent and aperiodic.

“Channel state information” (CSI) may include or refer to at least one of the following: a channel quality index (CQI), a rank indicator (RI), a precoding matrix index (PMI), an L1 channel measurement (e.g., RSRP such as L1-RSRP or SINR), a CSI-RS resource indicator (CRI), a SS/PBCH block resource indicator (SSBRI), a layer indicator (LI) and/or any other measurement quantity measured by the WTRU 102 from a configured CSI-RS or SS/PBCH (SSB) block.

“Channel conditions” may include or refer to any conditions relating to the state of the radio interface and/or channel, and which may be determined by the WTRU 102 from any of: a UE measurement (e.g., L1/RSSI, CQI/MCS, channel occupancy, power headroom, exposure headroom), L3/mobility-based measurements (e.g., RSRP, RSRQ, SINR, S-measure), an RLM state, and/or channel availability in unlicensed spectrum (e.g., whether the channel is occupied based on determination of a listen-before-talk (LBT) procedure or whether the channel is deemed to have experienced a consistent LBT failure).

“Scheduling information” (e.g., an uplink grant or a downlink assignment), such as a property thereof, may include or refer to least one of the following: a frequency allocation; an aspect of time allocation, such as a time instance and/or a time duration; a priority; a modulation and coding scheme (MCS); a transport block (TB) size; a number of spatial layers; a number of TBs to be carried; a transmission configuration indicator (TCI) state or sounding reference signal resource indicator (SRI); a number of repetitions; whether a grant is a configured grant type 1 (e.g., WTRU 102 immediately using the configured UL resources after receiving the configuration information), type 2 (e.g., WTRU 102 waiting until an explicit MAC CE indication before using the configured UL resources), or a dynamic grant.

An “indication”, such as by DCI, may include or refer to at least one of the following: an explicit indication, such as by a DCI field or by a RNTI used to mask the CRC of the PDCCH; or an implicit indication, such as by a property such as DCI format, DCI size, CORESET or search space, aggregation level, identity of a first control channel resource (e.g., index of first CCE) for a DCI). For example, a mapping between the property (e.g., of an implicit indication) and a value may be signaled, such as by RRC or MAC. For example, an explicit indication may be carried by a DL MAC CE.

A “SSB/RS” and “SSB and/or RS” may refer to any of a SSB, a RS or both.

Throughout the embodiments described herein, the network may include any of a base station (e.g., gNB, TRP, RAN node, access node, NTN node, IAB node, and/or RIS unit/node), core network function (e.g., AMF, SMF, PCF, NEF), and application function (e.g., edge server function, remote server function), for example. NES cells may refer to any of the network nodes that may be operating in an NES state/mode, including any of time, frequency, spatial and/or power domain adaptation modes.

Throughout the embodiments described herein, NES adaptations may include any of the adaptations at the network in the spatial domain (e.g., power off subsets of antenna ports, elements or panels), time domain (e.g., (de) activation of cell DTX/DRX, apply long periodicity or sparse transmissions of common signals/channels), frequency domain (e.g., disable certain carriers or BWPs), and/or power domain (e.g., apply lower power offset values).

A “NES state” or an availability state may refer to a cell state in which the cell, TRP or network node has activated at least one NES technique including at least one of: reduced SIB1 transmission (e.g., periodic or existence), reduced SSB transmission (e.g., periodic or existence), cell DTX, cell DRX, spatial domain adaptation (e.g., where a subset of antenna ports and/or elements are turned off), power domain adaptation (e.g., where a subset of signals/channels such as SSBs/TRS/CSI-RS are transmitted with reduced power or muted), triggering of SRS transmission with subset of resources, triggering of subset of TCI states, and/or the cell or TRP has turned off.

In certain representative embodiments, a WTRU 102 may determine whether it can transmit or receive on certain resources depending on a network availability state, such as which may imply a power savings status of the base station. An availability state may refer or correspond to a network energy savings state, a cell DTX mode, a cell DRX mode, and/or a gNB activity level. An availability state may be uplink or downlink specific, and may change from symbol to symbol, slot to slot, frame to frame, or on longer duration granularity. An availability state may be determined by the WTRU 102 or indicated by the network. An availability state may be, for example, any of “On”, “DL and UL active”, “UL only active”, “off”, “reduced transmit power”, “dormant”, “sleep (de)-activated”, “micro sleep”, “light sleep”, “deep sleep”, the active period of a sleep pattern, and/or the inactive period of a sleep pattern.

In certain representative embodiments, such as in a sleep pattern, an active period may refer or correspond to the time when the network may actively transmit DL signals/channels and/or the time when the network may blind decode for UL signals/channels. Such states may be abstracted by network configuration parameters and/or values, and a dynamic indication may point to the active availability state (e.g., by DCI or MAC CE signaling). The “Off” availability state or the non-active period of sleep pattern may imply that the gNB's baseband hardware is completely turned off. The “sleep” availability state may imply that the gNB wakes up periodically to transmit certain signals (e.g., presence signals, synchronization signals, and/or reference signals) and/or receive certain UL signals. In some availability states, some DL or UL resources may not be available during certain periods of time, and this enables the network to turn off baseband processing and other activities. For example, the WTRU 102 may be configured (e.g., by RRC) with periodic active and inactive periods per availability. Some measurement resources (e.g., SSBs or CSI-RSs) may only be made available in certain availability states, including: radio link monitoring (RLM), beam failure detection (BFD), radio resource management (RRM) measurements, CSI-RS feedback configuration, and/or a different power offset for CSI feedback.

In certain representative embodiments, under certain conditions, a WTRU 102 may further transmit a request to the network (e.g. wake-up request) to modify the availability state to a state for which resources that would satisfy WTRU requirements are available. The WTRU 102 may determine an availability state from reception of an availability state indication, such as by L1/L2 signaling (e.g., a group common DCI or MAC CE indication), or implicitly determine it from the reception of periodic DL signaling or lack thereof. The WTRU 102 may determine if a resource is available for transmission/reception and/or measurements for the determined network availability state if it is applicable in the active availability state. In addition, the WTRU 102 may also adapt its active C-DRX cycle, active spatial elements (e.g., antenna or logical ports), active TRPs, and/or paging occasions as a function of the signaled or determined availability state. The WTRU 102 may be configured with one or more sets of NES transmission and/or reception parameters per availability state, such as by broadcast or dedicated configuration signaling. The WTRU 102 may apply a NES parameter set according to the determined or signaled availability state. The WTRU 102 may apply one or more applicable configurations depending on the determined NES state. A set of NES parameters may include any of: a number of antenna ports, a C-DRX configuration, a measurement configuration (e.g., for RRM, RLM, and/or BFD), CSI feedback, a CSI-RS configuration, an SSB configuration, CHO or mobility candidates, and/or a set of active TRPs.

In certain representative embodiments, an availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, and/or a range of frequencies within a bandwidth part. For example, when an NES state changes in a cell, the WTRU 102 may receive an availability state change indication indicating that this change is just for that cell, for all cells at the same frequency, and/or a same RAT.

In certain representative embodiments, a WTRU 102 may consider the active availability state associated with a cell, carrier, TRP, and/or frequency band to be “Off”, “Deep sleep”, or “Micro sleep” after reception of a DL signaling that changes the cell's or TRP's availability state. For example, the WTRU 102 may receive a turn off command on broadcast signaling, RRC signaling, DCI (e.g. a group common DCI), or a DL MAC CE (e.g. indication part of PDSCH). The WTRU 102 may determine an availability state from reception of availability state indication from e.g. by L1/L2 signaling (e.g. a group common DCI or MAC CE indication) or broadcast signaling associated with an availability state.

For example, an availability state change indication may be part of a SI update or SIB signaling (e.g., in an existing SIB or in a new/separate SIB that is not read by legacy WTRUs). There may be a common time for all WTRUs in the cell to determine the availability state status.

For example, a WTRU 102 may determine a change of NES state change from the reception of a group common command L1 signaling (e.g., a group common DCI, a multi-stage DCI, a specific DCI format, or a DCI scrambled by a configured or specified NES-specific RNTI). L1 signaling may indicate one of the configured NES parameters sets to apply or may determine a delta configuration from the current set of parameters upon determining an NES state change. The WTRU 102 may determine a change of NES state may be applicable within a time gap (e.g., defined in units of SFNs, subframes, slots, symbols) upon reception of an indication from the network, where such a time gap may be predefined, preconfigured or indicated with the received indication. The WTRU 102 may transmit feedback/acknowledgment to the base station, such as multiplexed with UL data (e.g., part of an UL TB as a MAC CE or a sub-header indication), following the reception of a NES state change indication.

For example, a WTRU 102 may determine a change of NES state change from the reception of broadcast signaling associated with the NES state indication or change, including signaling in SIB(s) or part of a broadcast or multicast physical downlink shared channel (PDSCH). The WTRU 102 may be indicated with the NES state explicitly in the SIB. The WTRU 102 may be configured with one or more SIBs exclusively associated with the configuration of NES parameters. The WTRU 102 may be configured to receive a broadcast or multicast indication periodically. The WTRU 102 may determine an indication is mis-detected if not received on expected periodic occasions, if a certain number of misdetections is counted, and/or if a timer has elapsed since the last reception of the NES state indication. The WTRU 102 may start inter-cell, inter-frequency, and/or inter-RAT measurements, start a mobility procedure, and/or start evaluating configured CHO candidates following the determination of a misdetection of the NES state indication.

In certain representative embodiments, a WTRU 102 may implicitly assume a certain availability state associated with a cell, carrier, TRP, and/or frequency band (e.g., “Off, “deep sleep”, “micro sleep” or dormant”) from at least one of the following.

For example, a WTRU 102 may implicitly determine an availability state based (e.g., in part) on the reception of a command or signal indicating a change in availability state (e.g., a group common DCI in connected mode or RRC signaling or a presence signal). The WTRU 102 may determine an availability state implicitly from the reception of periodic DL signaling. The WTRU 102 may be configured or specified to associate an availability state with one or more DL signal types (e.g., SSB, partial SSB, and/or one or more periodicities).

For example, a WTRU 102 may implicitly determine an availability state based (e.g., in part) on the reception of a paging message, paging DCI, paging PDSCH, or a paging related signal (e.g., PEI), such as on a subset of POs (e.g., those aligned with a NES DRX cycle or a configured subset of PDCCH resources). The WTRU 102 may assume a certain availability state after reception of an indication part of the DCI or PDCCH scheduling paging (e.g., as a function of the P-RNTI, NES-RNTI or based on receiving an explicit indication, such as on a reserved bit). The WTRU 102 may assume a certain availability state after the reception of a paging message with a certain P-RNTI, a separately configured NES P-RNTI, or a NES group RNTI. The WTRU 102 may assume a certain availability state after the reception of a paging message with a certain P-RNTI. The WTRU 102 may be configured with one more PEI subgroups for NES, where a subgroup may be associated with one or more availability states. The WTRU 102 may assume a certain availability state after reception of a PEI with an NES subgroup, such as where the subgroup is configured and/or associated with the availability state. The indication of the availability state or the availability state switch may be indicated in the paging payload, such as a flag part of the paging message or the short message. Such a paging indication may further indicate an alternative cell to monitor paging on while the cell from which the signaling was received is off, asleep, or in a NES state. Such a paging indication may further indicate or signal applicable reconfiguration parameters (e.g., for initial access, applicable PRACH resources, applicable SSB/RS occasions, applicable SI cycle, and/or the applicable cell(s) and associated availability states).

For example, a WTRU 102 may implicitly determine an availability state based (e.g., in part) on the reception of a TCI state indication, such as indicating the activation/deactivation or triggering of one or more TCI states. Such a TCI state may include or be associated with QCL sources (e.g. SSB, on-demand SSB, slim/lean SSB, TRS, CSI-RS resource, SRS resource, PRS, SRSp), QCL types (e.g., information on doppler shift, doppler spread, delay spread, average delay, spatial receive parameter), and/or spatial configuration information (e.g., parameters for an UL transmit spatial filter).

For example, a WTRU 102 may implicitly determine an availability state based (e.g., in part) on the base station's DTX status (e.g., whether the gNB is in active time or an associated activity timer is running).

For example, a WTRU 102 may implicitly determine an availability state based (e.g., in part) on the lack of detection of a presence indication. A WTRU 102 may determine an availability state associated with the cell (e.g., “off” or “deep sleep”) if a presence indication was not detected on one or more presence indication occasions. The WTRU 102 may assume or change the cell's availability state after a number of consecutive misdetections or after a timer expires following no detection of a presence signal. The WTRU 102 may determine an availability state is active or inactive after expiry of a timer associated with the availability state. Such a timer may be configured and/or maintained in CONNECTED mode only, or also in other states (e.g., IDLE and/or INACTIVE states). The WTRU 102 may determine an availability state implicitly from the lack of reception of periodic DL signaling. For example, the WTRU 102 may be configured with a signal quality threshold (e.g., an RSRP threshold) and if the WTRU 102 does not detect a signal associated with an availability state (e.g., a presence signal or an SSB) with a signal strength above the threshold, the WTRU 102 may assume that this availability state is not active and may assume a different availability state. This criterion may be also coupled with the lack of detection of an identifying sequence of the presence signal (e.g., detection of the PSS sequence).

For example, a WTRU 102 may implicitly determine an availability state based (e.g., in part) on the time of day. A WTRU 102 may be configured to automatically assume a certain availability state (e.g., off, sleep, or dormant) for a configured subset of cells (e.g., capacity boosting cells) depending on the time in the day. For example, the WTRU 102 may determine that a capacity boosting cell has an availability state as “On” in certain hours of the day, “Deep sleep” in other configured hours, and “Off” in a third set of configured hours of the day or night.

For example, a WTRU 102 may implicitly determine an availability state based (e.g., in part) on the availability state of an associated cell (e.g., another carrier of the same MAC entity, another carrier in the same cell group, another carrier in the same gNB, another sector in the same gNB, and/or a configured associated cell or capacity boosting cell).

For example, a WTRU 102 may implicitly determine an availability state based (e.g., in part) on the detection of a PSS only signal or a simplified/stripped down SSB signal.

For example, a WTRU 102 may implicitly determine an availability state based (e.g., in part) on the detection of an RS signal (e.g. CSI-RS, PRS, TRS) or the lack thereof.

For example, a WTRU 102 may implicitly determine an availability state based (e.g., in part) on the WTRU 102's RRC state (IDLE, INACTIVE, or CONNECTED mode).

For example, a WTRU 102 may implicitly determine an availability state based (e.g., in part) on whether paging has been received, such as within a configured time window.

For example, a WTRU 102 may implicitly determine an availability state based (e.g., in part) on whether system information (e.g., periodic SI or a subset of SIBs) have been received, such as within a configured time window.

For example, a WTRU 102 may implicitly determine an availability state based (e.g., in part) on the measured channel condition(s) (e.g., being below or above a threshold). The WTRU 102 may assume a change of NES state based on a change of measured channel conditions, or making a channel measurement, below or above a threshold. For example, the WTRU 102 may use degradation in measurements of SSBs and/or CSI-RSs, such as in combination with other signaling, to determine the NES state. For example, a configured window following a DCI reception can be used to measure SSBs and/or CSI-RSs for degradation, and, if a delta of SSB-RSRP drop is measured, the WTRU 102 may determine that the NES state has changed and assume associated actions for the NES state (e.g., trigger for CHO candidate selection or for group scheduling for a mobility command).

In certain representative embodiments, a WTRU 102 may be configured to monitor an indication that may characterize the level of network activity (e.g., an availability state). The network activity may be associated with a base station (e.g., gNB) and/or a cell. The WTRU 102 may assume the same availability state for all cells part of the same base station (e.g., gNB or a gNB set), such as cells of the same scheduler, control unit (CU) or MAC entity. The network activity indication (e.g., the presence indication) may include a channel (e.g., a PDCCH) and/or a signal (e.g., a sequence). The activity indication or the NES state change indication or command may indicate the level of activity the WTRU 102 may expect from the associated base station and/or cell (e.g., reduced activity). The activity indication may contain activity information of other base stations and/or cells. The activity indication may be a PDCCH containing group common signaling. For example, the network may transmit a group common DCI to a group of WTRUs (e.g., WTRUs in the serving cell) indicating a change of an activity state or activity level in the UL and/or DL. The CRC of the PDCCH may be scrambled with a dedicated “activity indication RNTI” or an “NES-RNTI”.

A WTRU 102 may be configured with at least one CORESET and/or SS associated with the monitoring occasions of the activity indication PDCCH. The indication may include a go-to-sleep signal (e.g., a predefined sequence). When the WTRU 102 detects this sequence, the WTRU 102 may expect a reduced activity level over a specific time duration. The WTRU 102 may activate C-DRX for the period of time indicated. As another example, two sequences may be used to indicate regular activity and reduced activity. The signaling within the PDCCH or the activity indication may include at least one of the following.

For example, the signaling or activity indication may include an expected activity level of the associated gNBs and/or cells over a specific time interval (e.g., an availability state). The activity levels may be predetermined and/or configured and may, for example, include regular and reduced activity levels. The signaling may indicate the activity level. For example, a bit of “1” may indicate regular activity and a bit of “0” may indicate reduced activity.

For example, the signaling or activity indication may, for each activity level (e.g., availability state), include and/or define transmission and reception attributes. For example, during reduced activity, a WTRU 102 may not be expected to monitor certain PDCCH search spaces, including common SSs (CSSs) and/or UE-specific SSs (USSs), and/or receive a certain type of PDSCH (e.g., all PDSCH), and/or transmit PUCCH and/or PUSCH, and/or perform certain measurements. The WTRU 102 may start or stop monitoring PDCCH and/or TCI states associated with the determined NES state, including PDCCH resources or TCI states associated with (de) activated TRPs and/or spatial elements.

For example, the signaling or activity indication may include a set of configurations associated with an activity level and may be used or applied when that activity level is indicated (e.g., an NES parameter set). For example, SS configurations, CSI reporting configurations, indices of transmitted SSBs, etc. Each set of configurations may have an attribute associated with an activity level. For example, a tag that can be set to “reduced activity”.

For example, the signaling or activity indication may include a time interval over which an activity level is assumed and may be signaled in the PDCCH or part of the activity indication. The time interval may be indicated using a bitmap where each bit in the bitmap may be associated with a specific duration (e.g., a slot, a frame, or other transmission time interval). For example, a bit of “1” may indicate regular activity and a bit of “0” may indicate reduced activity (e.g., on an associated frame). The time interval may be indicated with a start time and a length of interval. The start time may be defined or it may be determined by adding a fixed offset to the time the indication is received. The length of the interval may be configured or signaled in the indication PDCCH.

For example, the signaling or activity indication may include the time interval over which an activity level is assumed and may be predetermined. The WTRU 102 may assume an interruption delay (or more generally a time till the NES state changes) after the NES state change command reception (e.g., after the last symbol or slot on which the command was received). The interruption time can be in absolute time, a number of symbols, or a number of slots.

In certain representative embodiments, a WTRU 102 may determine that an UL and/or DL resource and/or signal is available for transmission, reception, and/or measurements for the determined network availability state if it is applicable in the active availability state. The WTRU 102 may determine that a subset of measurement resources and/or signals (e.g., SSBs, CSI-RS, TRS, PRS) are not applicable in certain availability states. The WTRU 102 may determine that a subset of UL or DL resources (e.g., PRACH, PUSCH, PUCCH) are not applicable in certain availability states. The WTRU 102 may transmit some uplink signals (e.g., only) in a subset of network availability states (e.g., SRS, SRSp, PRACH, UCI).

Herein, the terms “network NES state” and “cell NES state” may be used interchangeably. A WTRU 102 may know the cell NES state for one or more cells (e.g., through network configuration and indication). A network NES state may refer to the NES states of one or more cells which could be serving cells, neighbor cells, etc. A NES state may imply an activation state only for a NES state, while another NES state may correspond to the deactivation state. The terms network availability state, cell turned off, SSB-less, SIB1-less operation, reduced SIB1/SSB periodicity state, (de)-active cell DTX mode/configuration, and/or NES state may be used interchangeably. The WTRU 102 may determine an SSB/SIB1 transmission state (e.g., whether they are transmitted and/or periodicity) implicitly from a determined active availability state, and vice-versa.

Herein, a “NES cell” may refer to a cell that is applying at least one NES technique, is in a NES state (e.g., activated NES state), and/or is capable or configured to apply an NES technique at some point. Herein, a “non-NES cell” may be used to refer to any cell that is not designated as a NES cell per this definition (e.g., not in a NES state or cannot/doesn't apply a NES technique). For example, the designation of which cells can be NES cells may be configured (e.g., by broadcast or dedicated signaling).

In certain representative embodiments, in one or more NES state(s), a WTRU 102 may transmit a wake up signal (e.g., PRACH, SR, PUCCH, UCI multiplexed in PUCCH/PUSCH, a MAC CE or UE assistance information, SRS resource) to request a change in the NES state, additional UL or DL resources, reception of on-demand SSB, reception of on demand SIB 1/SI, or activation of a given cell (e.g., one that is in a NES state). Triggers for the WTRU 102 to transmit a wake-up signal and/or request reception of an on demand SSB include: detection of a reference signal, detection of a change of TCI state, making a channel measurement on the cell or an associated cell less than or greater than a threshold, arrival of new data (e.g., for a given LCH/LCG), amount of buffered data exceeding a threshold (e.g., for a given LCH/LCG), based on positioning being within a given range, based on triggering BSR/SR, based on triggering a L3 mobility events, based on the WTRU or cell DTX/DRX status, based on expiry of a timer, and/or the WTRU 102 receiving a request from higher layers to transmit an on-demand SSB request.

In certain representative embodiments, a WTRU 102 may transmit or receive a physical channel and/or reference signal according to at least one spatial domain filter. Herein, the term “beam” may be used to refer to a spatial domain filter. The WTRU 102 may transmit a physical channel or signal (e.g., PUCCH, PUSCH, SRS) using a same spatial domain filter as used for receiving an RS (e.g., CSI-RS) and/or a SS block. The WTRU 102 transmission may be referred to as a “target”, and the received RS and/or SS block may be referred to as a “reference” or “source”. For example, a WTRU 102 may be said to transmit a target physical channel or signal according to a spatial relation with a reference to a RS or SS block.

For example, a WTRU 102 may transmit a first physical channel or signal according to the same spatial domain filter as the spatial domain filter used for transmitting a second physical channel or signal. The first and second transmissions may be referred to as a “target” and a “reference” (or “source”), respectively. In such cases, the WTRU 102 may be said to transmit the first (e.g., target) physical channel or signal according to a spatial relation with a reference to the second (e.g., reference) physical channel or signal. A spatial relation may be implicit, configured by RRC and/or signaled (e.g., by MAC CE or DCI). For example, a WTRU 102 may implicitly transmit PUSCH and DM-RS of PUSCH according to the same spatial domain filter as an SRS indicated by an SRI indicated in DCI or configured by RRC. In another example, a spatial relation may be configured by RRC for an SRI or signaled by MAC CE for a PUCCH. Such a spatial relation may also be referred to as a “beam indication”.

For example, a WTRU 102 may receive a first (e.g., target) downlink channel or signal according to the same spatial domain filter, or one or more spatial reception parameters, as a second (e.g., reference) downlink channel or signal. For example, such an association may exist between a physical channel, such as PDCCH or PDSCH, and its respective DM-RS. At least when the first and second signals are reference signals, such an association may exist when the WTRU 102 is configured with a quasi-colocation (QCL) assumption type D between corresponding antenna ports. Such an association may be configured as a TCI state. A WTRU 102 may be indicated an association between a CSI-RS or SS block and a DM-RS by an index to a set of TCI states (e.g., configured by RRC and/or signaled by MAC CE). Such an indication may also be referred to as a “beam indication”.

Herein, an “SSB” may refer to one or more SSB beams (e.g., spatial relations) within a collection of SSBs (e.g., an SSB burst). An SSB may refer to a beam or a CSI-RS resource related to the beam, or vice versa. SSB, SSBs, and/or SSB burst may loosely refer to one or more beams transmitted from a TRP or a network node.

Throughout the embodiments described herein, the terms “RS”, “RS beams”, “SSB” and “SSB beams” may be used interchangeably. Also, the terms “RS configuration”, “RS beam configuration”, “NES-RS configuration”, “SSB pattern” and “SSB configuration” may be used interchangeably.

### Overview

In certain representative embodiments, a WTRU 102 may receive configuration information associated with one or more SSBs and/or one or more RSs for NES.

In certain representative embodiments, a WTRU 102 may receive configuration information and/or sub-configurations (e.g., a subset of parameters associated with a configuration, or an update to a configuration) associated with one or more RSs (e.g., for NES).

For example, the RSs may be applicable in DL and/or UL. The RSs may include any of the following: SSBs, enhanced RSs, measurement RSs, NES-RSs, and/or light-RSs.

For example, SSBs may include legacy NR SSBs including cell defining SSBs (CD-SSBs) and/or non-cell defining SSBs (NCD-SSBs). The frequency locations of the SSBs may be on and/or off a synchronization raster (e.g., GSCN, ARFCN, or other sync raster).

For example, enhanced RSs may include new RSs and/or SSBs that may include additional or lower sets of resources, signals, and/or parameters than those in legacy SSBs, including any combination of PSS/SSS, MIB, PBCH, pre-SIB1, SIB1, RACH configuration, UL WUS configuration, PUCCH resource configuration, small data transmission (SDT) resources, SRS resources, etc.

For example, measurement RSs may include CSI-RSs, tracking RSs (TRSs), and/or phase tracking RSs (PTRSs).

For example, NES-RSs may include on-demand SSBs (OD-SSBs) that may be available in a certain duration and/or window with a certain periodicity and/or inter-burst gap from a reference or start time onwards, and/or UE/group-specific RSs (e.g., a set of RS beams that may be triggered/transmitted for a WTRU or group of WTRUs).

For example, light-RSs may include RSs that may contain a combination of one or more synchronization signals, PSS, SSS, discovery reference signal (DRS), PBCH only, or SIB1 only.

In certain representative embodiments, a configuration for a RS (e.g., a RS configuration) may be applicable for supporting one or more NES adaptations in any of (e.g., different) time, frequency, spatial, and/or power domains. Such configurations and/or parameters may be applicable for any of the embodiments, solutions, and procedures described herein. In examples described herein, the terms ‘NES-RS’, ‘Enhanced RS’, ‘measurement RS’ and ‘light RS’ may be used interchangeably when referring to any reference signals that may or may not be identical to the legacy SSBs.

In certain representative embodiments, any of the configurations and/or sub-configurations associated with a RS, at least in part, may be received in broadcast transmission (e.g., MIB, SIBx—where x is an integer) and/or in dedicated RRC signaling (e.g., in a RRCReconfiguration message) during CONNECTED mode or in INACTIVE/IDLE mode (e.g., a RRCRelease message, when transitioning from CONNECTED mode to INACTIVE mode, paging DCI, PEI-DCI).

In certain representative embodiments, any of the configurations, sub-configurations and/or parameters may be received by the WTRU 102, at least in part, in one or more dynamic signaling indications (e.g., in MAC CE or DCI) or in NES and/or cell activity indications, for example. Such NES and/or cell activity indications may be received in RRC signaling, MAC CE, DCI (e.g., UE-specific or group common DCI), and/or PDSCH, for example. In an example, a WTRU 102 may receive a first subset of parameters associated with one or more RS configurations in MIB, SIBx, or RRC signaling, and a second subset of parameters or an update to the parameters in the first subset may be received in dynamic signaling (e.g., MAC CE, DCI).

In certain representative embodiments, a WTRU 102 may receive, in configuration information, information indicating one or more of the following parameters associated with an SSB and/or RS configuration or sub-configuration: an identifier (e.g., index) of the configuration; an identifier (e.g., index) of resource or a resource set; RS resources; RS ports; a resource type; active SSB or RS resources in a burst; a periodicity; a usage type; an offset; a bandwidth; frequency hopping information; a guard period; comb pattern information; a sequence type; a beam transmission power; and/or power control parameters.

For example, a SSB and/or RS configuration (or sub-configuration) may include indexes and/or IDs of one or more SSB and/or RS configurations, SSB and/or RS resource sets, or resources.

For example, a SSB and/or RS configuration (or sub-configuration) may include RS resources such as time, frequency, and/or spatial domain resources. Time domain resources may include any of a number of symbols per slot (e.g., 1, 2, 4 or more symbols per slot), a start offset symbol, a repetition factor, a burst periodicity, a duration/window of RS transmission, a time gap between beams/RS/bursts, and/or a comb/interleaving pattern. When a RS configuration corresponds to an SSB transmission configuration or pattern, the configuration or pattern may indicate the candidate locations of the SSBs in SSB bursts in terms of any of the following parameters: SFN index (e.g., even or odd indexes), half-frame index (e.g., first or second half of a frame), subframe, slot, and/or symbol. Frequency domain resources may include any of a number of PRBs, a center frequency, a start offset PRB, a repetition factor, and/or a comb pattern. Spatial domain resources may include any of a number of RS/beams in a burst, a position of RS in a burst (e.g., via bitmap), a beamwidth of RS beams (e.g., wide-beams, narrow beams). Each RS (sub-) configuration may include resources which may or may not overlap with the resources in other RS (sub-)configurations, for example. In an example, the resources allocated for one or more RS (sub-)configurations may correspond to an RS resource pool.

For example, a SSB and/or RS configuration (or sub-configuration) may include RS ports, such as a number and/or a set of Transmit and/or receive ports.

For example, a SSB and/or RS configuration (or sub-configuration) may include a resource type. The resource type may correspond to the time-domain behavior of a resource configuration, such as periodic, semi-persistent, or aperiodic behavior.

For example, a SSB and/or RS configuration (or sub-configuration) may include active SSB/RS resources in a burst. For an example SSB configuration, a parameter may indicate the SSB positions in a burst. The active SSBs in a burst (e.g., index(es) of SSBs that are transmitted) may be indicated via a bitmap with different lengths. As an example, a bitmap length of 4 bits may be used for FR1 when there may be 4 SSBs in a burst. A bit of ‘1’ may indicate an SSB is active and/or transmitted and a bit of ‘0’ may indicate the SSB is off.

For example, a SSB and/or RS configuration (or sub-configuration) may include a periodicity. For an example SSB configuration, a parameter may indicate the periodicity of SSB bursts on a cell (e.g., 5 ms, 20 ms, 160 ms).

For example, a SSB and/or RS configuration (or sub-configuration) may include a usage type. A WTRU 102 may be configured with any of beam management, RLM, NES, codebook/non-codebook, antenna switching for using signals associated with the configuration.

For example, a SSB and/or RS configuration (or sub-configuration) may include a slot level periodicity and slot level offset (e.g., for periodic or semi-persistent RSs).

For example, a SSB and/or RS configuration (or sub-configuration) may include a RS resource and/or beam bandwidth.

For example, a SSB and/or RS configuration (or sub-configuration) may include frequency hopping information. A WTRU 102 may be configured with one or more hopping patterns that may be applied over a set of RS resources in any of the time, frequency, and/or spatial domains. In a hopping pattern, a partial set of RS resources in the frequency domain (e.g., PRBs) may be used in each time domain resource (e.g., symbol) for transmitting or receiving the RS using a different spatial relation. Such a hopping pattern may correspond to one or more NES adaptations or states, for example.

For example, a SSB and/or RS configuration (or sub-configuration) may include a guard period, such as a number of symbols, slots, milliseconds (ms) or other time intervals. A WTRU 102 may apply the guard period when switching between different RS (sub-)configurations or when switching between different receive ports for the RS reception.

For example, a SSB and/or RS configuration (or sub-configuration) may include RS comb pattern information. For an example SSB configuration, a parameter may indicate a transmission comb value, which may be associated with the gap in terms of the number of PRBs or number of symbols or slots between two RS resources in the frequency and/or time domains. A (e.g., each) RS configuration may include one or more RS comb patterns, where each pattern may be associated a different set of parameters (e.g., offset value, cyclic shift) and/or RS resources in the time, frequency, and/or spatial domains. A comb pattern may include RS resources in different symbols (e.g., within one slot or across multiple slots) or slots, where the RS in different symbols and/or slots may be received with a different spatial relation or filter. When an RS is configured with periodic or semi-persistent RS resources, the RS comb pattern (e.g., using resources in time, frequency, and/or spatial domains) may be repeated, such as in each period. When an RS is configured with aperiodic RS resources, the RS burst may include RS resources in the time, frequency, and/or spatial domains.

For example, a SSB and/or RS configuration (or sub-configuration) may include a comb offset hopping pattern (e.g., with repetition).

For example, a SSB and/or RS configuration (or sub-configuration) may include a RS sequence type and/or identifier (e.g., m-sequence, Zadoff-Chu sequence).

For example, a SSB and/or RS configuration (or sub-configuration) may include a beam Transmit power. For example, a SSB configuration (or sub-configuration) may include a SS-PBCH-Block power.

For example, a SSB and/or RS configuration (or sub-configuration) may include power control parameters, such as any of alpha, p0, pathloss reference RS, power per RB block, and/or RS power control adjustment states (e.g., closed loop factor).

In certain representative embodiments, a WTRU 102 may be configured with one or more of the following parameters associated with the SSB and/or RS power adaptation.

For example, a WTRU 102 may be configured with an adaptation type and/or pattern. A uniform or non-uniform power adaptation pattern may be applied for SSB and/or RS beams. An adaptation pattern may be referred to by an index or other identifier.

For example, a WTRU 102 may be configured with a reference beam. An index or other identifier of an SSB and/or RS beam (e.g., SSB, CSI-RS, TRS) may be predefined, preconfigured or indicated to serve as a reference beam, such as for determining any of power offset and/or adjustment and/or RSRP, RSRQ, and/or pathloss thresholds. A set of SSB/RS beams (e.g., in a burst, period, pool, configuration, cell) may be associated with at least one reference beam. A reference beam may be configured to be located within an SSB burst (e.g., one SSB out of K SSBs in a burst) or may be outside of a burst (e.g., a separate signal outside of an SSB burst). In an example, a reference beam may be transmitted with a peak Transmit power. In an example, a reference beam may serve as a QCL source for other associated beams.

For example, a WTRU 102 may be configured with a peak power (e.g., value). A peak power may be a maximum Transmit power used for one or more SSB and/or RS beams in any of a burst, period, configuration, pattern, and/or cell. In an example, the peak power may correspond to the SS-PBCH block power. In an example, a reference beam (e.g., an SSB/RS beam within or outside of a burst) may be transmitted with a peak power.

For example, a WTRU 102 may be configured with a power offset and/or adjustment. For example, a difference and/or offset value may be applied for the Transmit power of a beam with respect to a reference Transmit power (e.g., peak power). A WTRU 102 may be configured with a set of power offset values that may be associated with one or more SSB and/or RS beams. In an example, when configured with K SSB beams with at least one SSB serving as a reference beam, the Transmit power of the K beams may be determined as: Transmit power (SSB #0)=Peak power-powerOffset1; Transmit power (SSB #1)=Peak power-powerOffset2, and so forth.

For example, a WTRU 102 may be configured with a repetition parameter, such as a number of consecutive occasions, bursts, and/or periods in which an SSB and/or RS beam may be transmitted with a same power level (e.g., peak power, or adjusted peak power as modified by a power offset or adjustment).

For example, a WTRU 102 may be configured with a start offset. A start offset may be applied when configured with a power adaptation pattern for indicating the first SSB burst containing an SSB index that is transmitted with a certain Transmit power level (e.g., peak power).

For example, a WTRU 102 may be configured with a power periodicity. A power periodicity may be a duration between at least 2 occasions, bursts, and/or periods in which the Transmit power of an SSB and/or RS beam may be transmitted with a same power level (e.g., peak power, or adjusted peak power as modified by a power offset or adjustment).

For example, a WTRU 102 may be configured with a power incrementing or decrementing cycle. A power cycle may be a duration between at least two occasions, bursts, and/or periods in which the Transmit power of an SSB and/or RS beam may be incremented or decremented from a maximum or minimum power offset value to a minimum or maximum power offset value.

For example, a WTRU 102 may be configured with power muting and/or masking. A power muting and/or masking parameter may indicate any of the on or off status and/or a power offset level that may be applied for a set of SSB and/or RS beams in a burst, period, and/or configuration. In an example, when a masking pattern configured with a power offset value is applied for a set of K SSBs in a burst, the same power offset level may be applied for the K SSBs. Power muting and/or masking may be defined by a bitmap with a configured length associated with a set of SSB and/or RS beams.

For example, a WTRU 102 may be configured with one or more measurement (e.g., RSRP and/or RSRQ) thresholds. Threshold values may be used for determining the received power level and/or received quality of any of the measured SSB and/or RS beams.

For example, a WTRU 102 may be configured with one or more pathloss thresholds. These threshold values may be used for determining pathloss of any of the measured SSB and/or RS beams.

In certain representative embodiments, a WTRU 102 may be configured with one or more of the following properties and/or parameters on or associated with TCI states associated with RSs.

For example, a WTRU 102 may be configured with a property associated with a quantity. One or more TCI states (e.g., indicated by index or other identifier) may be associated with a set or pool (e.g., indicated by a pool index or identifier). A (e.g., each) TCI state may be associated with one or more RSs (e.g., SSB, NES-RS, CSI-RS, TRS, SRS) as a QCL source.

For example, a WTRU 102 may be configured with a property associated with a RS (sub-) configuration. A (e.g., each) RS (sub-)configuration may be associated with one or more TCI states. One or more RS (sub-)configurations may be associated with a common pool of TCI states. TCI states in different RS (sub-)configurations may be non-overlapping. As an example, a first RS configuration may be associated with a set of TCI states {TCI1, TCI2} and a second RS configuration may be associated with TCI states {TCI3, TCI4}.

For example, a WTRU 102 may be configured with a property associated with triggering (e.g., activation and/or deactivation). One or more TCI states may be activated and/or deactivated upon configuration (e.g., via RRC signaling) or with dynamic signaling (e.g., MAC CE and/or DCI). As an example, the granularity of TCI state (de) activation may be performed per TCI state, per-TCI state pool, per RS configuration, and/or per RS sub-configuration.

For example, a WTRU 102 may be configured with one or more parameters associated with TCI states. The parameters may include QCL information, such as any of QCL sources and/or QCL types.

For example, a WTRU 102 may be configured with one or more QCL sources associated with TCI states. QCL sources may be indicated, identified or otherwise determined based on identifiers and/or indexes (e.g., RS ID/index, SSB index, NES-RS index, CSI-RS resource ID). QCL sources may be indicated, identified or otherwise determined based on a type of resource and/or signal (e.g., periodic, semi-persistent, aperiodic, on-demand, slim, lean). As an example, a (e.g., each) TCI state may be associated with a RS resource and/or beam as a QCL source or reference signal and/or beam for determining a spatial relation.

For example, a WTRU 102 may be configured with one or more QCL types associated with TCI states. The QCL types may include any of Type A (e.g., doppler shift, doppler spread, average delay, delay spread), Type B (e.g., doppler shift, doppler spread), Type C (e.g., average delay, doppler shift), and/or Type D (e.g., spatial receive).

In certain representative embodiments, a WTRU 102 may receive, such as part of configuration information, information indicating one or more events, conditions and/or threshold values for selecting or using any of the RS (sub-)configurations, RS resources, and/or TCI states for RS as follows.

For example, a WTRU 102 may receive information indicating one or more measurement threshold values. The threshold values may correspond to, or be used in conjunction with, EPRE, RSRP, RSRQ, SINR, CQI, pathloss, and the like. For example, the WTRU 102 may select an RS (e.g., an SSB beam as a pathloss RS), when the measurements made on an associated and/or replacement RS and/or TCI state is higher, or lower, than a RSRP threshold. The threshold values may be configured and/or indicated on the basis of any of per RS, per beam, per burst, and/or per (sub-)configuration.

For example, a WTRU 102 may receive information indicating timing information, such as a start time threshold, an end time threshold, and/or a time window or duration. For example, an RS resource and/or beam may be received if it begins no later than a start time of T1 symbols, slots, or ms after the WTRU 102 receives an indication associated with activation of the RS (sub-) configuration to which the RS resource belongs. For example, an RS resource and/or beam may be received if it ends no earlier than an end time of T2 symbols, slots, or ms after the WTRU 102 receives an indication associated with deactivation of the RS (sub-)configuration to which the RS resource belongs. For example, a time window may be determined using a start offset time and a length. For example, the WTRU 102 may use one or more RS configurations that may be accommodated within the time window for RS transmission.

For example, a WTRU 102 may receive information indicating transmission power and/or reception power information. For example, the WTRU 102 may receive one or more (e.g., transmission) power thresholds. As an example, the WTRU 102 may use one or more RS resources (e.g., in the time and/or frequency domains) if the received power (e.g., total power in RS resources in a transmission instance or interval) is less than a first power threshold value and/or greater than a second power threshold value. For example, the WTRU 102 may receive one or more power spectral density (PSD) thresholds. As an example, the WTRU 102 may use one or more RS resources (e.g., in the time and/or frequency domains) if the PSD over the RS resources is less than a first PSD threshold value and/or greater than a second PSD threshold value.

For example, a WTRU 102 may receive priority information. For example, one or more priority values may be associated with any of RS (sub-)configurations, RS resources, RS parameters, and/or TCI states. As an example, a WTRU 102 may use an RS configuration, when the priority associated with the RS configuration is higher than a first priority threshold value and/or lower than a second priority threshold value.

For example, a WTRU 102 may receive information indicating one or more events. An event may be a change of RSRP measurements of an RS (e.g., when the network does NES adaptation). An event may be an indication of TCI state(s) changes. An event may be the detection of RRM, BM, and/or mobility events (e.g., HO, RLM, RLF events).

It should be appreciated that any of the foregoing configuration information, parameters, and/or properties described above may be implemented in any solutions, procedures or other embodiments described herein.

### SSB/RS Determination During Transmission Power Adaptation

In certain representative embodiments, during SSB power adaptation, a WTRU 102 may determine one or more SSB/RS beams, such as may be used for any of PL reference signals (e.g., for PRACH or SRS transmission) and/or as QCL sources for other signals or channels (e.g., DMRS of PDCCH, DMRS of PDSCH) and/or measurement objects (e.g., for L3, L2, and/or L1 measurements). SSB power adaptation may refer to changing the Transmit power of the SSBs on the basis of per-beam level, per-burst level or per (sub-)configuration level. For example, Transmit power may be adapted from a case where all SSBs in a burst may be equal or uniform to a case where the Transmit power may be unequal or non-uniform. Power adaptation may correspond to adapting from one power pattern to another power pattern. An indication of power adaptation may be received by the WTRU 102 from the network via semi-static and/or dynamic signalling in any of broadcast (e.g., MIB, SIBx, group common DCI) and UE-specific signaling.

As used herein, the terms “SSB configuration”, “RS configuration”, “SSB sub-configuration”, “RS sub-configuration”, “power adaptation pattern” and/or “SSB power pattern” may be used interchangeably when referring to any of uniform or non-uniform transmit power levels applied for one or more SSB and/or RS beams over a set of one or more bursts, periods and/or time windows.

In certain representative embodiments, a WTRU 102 may be configured with one or more parameters associated with SSB and/or RS beam power adaptation.

In certain representative embodiments, a WTRU 102 may receive configuration information, parameters, and/or indications from the network which are associated with SSB power adaptation(s). Such configuration(s) and/or parameter(s) may be received, entirely or one or more parts, in any of L3/SI/RRC signalling, L2/MAC signaling (e.g., MAC CE), or L1/PDCCH (e.g., DCI) indications in CONNECTED and/or IDLE/INACTIVE modes. Such configuration(s) and/or indication(s) may include any (e.g., combination) of one or more of the following.

For example, a WTRU 102 may receive information indicating a set of SSB and/or RS beams. The WTRU 102 may be configured with one or more SSB and/or RS beams that may be grouped into one or more sets of RS beams. Such a set may refer to any of a burst, period, and (sub-)configuration. Such a set may be indicated by an index or other identifier

In an example, a WTRU 102 may be configured with a first set of SSB and/or RS beams that may be subject to SSB power adaptation (e.g., the transmit power of SSB and/or RS beams may be dynamically adapted) and a second set of SSB and/or RS beams that may not be adapted (e.g., transmit power of the beams may be fixed, constant, or cannot be dynamically adapted).

In an example, a set of SSB and/or RS beams may be associated with common properties and/or characteristics. Common properties of the RS beams may include any of: a time domain property (e.g., all beams are transmitted within an SFN in a SSB burst), a power domain property (e.g., transmit power of all beams in a set is within a maximum-minimum power range), a spatial domain property (e.g., share common QCL source, common QCL type), a power pattern type, a general type (e.g., legacy SSB type, new SSB type), a RS type (e.g., SSB, CSI-RS), a resource type (e.g., periodic, semi-persistent, aperiodic, on-demand), a periodicity, a number of beams in a burst, priority or importance of RS beams, a size (e.g., of beamwidth), a frequency band, and/or BWP, and the like.

For example, when any of the property or association for at least one of the SSB and/or RS beams in a set is changed or adapted, a similar (or complementary) change or adaptation may apply for one or more of the other SSB and/or RS beams in the set.

For example, a WTRU 102 may receive information indicating SSB and/or RS beam power adaptation patterns. A WTRU 102 may be configured with one or more power adaptation patterns, where a pattern may refer to transmit power levels that may be applied to one or more SSB and/or RS beams over one or more transmission instances. A transmission instance in the time domain may include or refer to any of a SFN, half-frame, subframe, burst, and/or period. As an example of a power adaptation pattern, an SSB index K may be transmitted with a power of M1 dBm when transmitted in SFN index N and transmitted with a power of M2 dBM when transmitted in SFN index N+n.

The following describe examples of different power adaptation patterns that may or may not be applicable during SSB transmission (e.g., in a case of N SSBs per burst, SSB burst periodicity of L).

As a first power adaptation pattern example, the transmit power levels of N SSBs in a burst may be equal and/or uniform. There may be no power offset configured for the SSBs in this pattern. The transmit power of the SSBs in a burst may be the same across multiple periods.

As a second power adaptation pattern example, the transmit power levels of N SSBs in a burst are unequal and/or non-uniform. At least one SSB in a burst is transmitted with a higher transmit power (e.g., peak power level) than other SSBs across multiple periods. Such an SSB with a high transmit power may be the same SSB (e.g., same SSB index) across multiple periods. Such an SSB may be configured as a reference SSB. The power offset (e.g., difference in transmit power) between the reference SSB and other SSBs in a burst (e.g., for N−1 non-reference SSBs) may be different per SSB, and/or the power offset may be a fixed value across multiple periods.

As a third power adaptation pattern example, the transmit power levels of N SSBs in a burst may be unequal and/or non-uniform. At least one SSB in a burst may be transmitted with a higher transmit power (e.g., peak power level) than other SSBs across multiple periods. An SSB with a high transmit power may be a different SSB (e.g., different SSB index) in different periods. In this case, the reference SSB may be different in different periods. The different time instances when an SSB may be transmitted with the high transmit power in a burst may correspond to a peak power periodicity value. A peak power periodicity may be longer than the SSB burst periodicity. The transmit power of other SSBs (e.g., N−1 non-reference SSBs) may be the equal and/or uniform across multiple periods. The power offset (e.g., difference in transmit power) between the reference SSB and other SSBs in a burst (e.g., N−1 non-reference SSBs) may be the same for all other SSBs and/or the offset may be a fixed value across multiple periods.

As a fourth power adaptation pattern example, the transmit power levels of N SSBs in a burst may be unequal and/or non-uniform. The transmit power of one or more SSBs in a burst may follow an increasing or decreasing pattern in each period. For example, the transmit power of SSB #4 may be 5 dBm in a first period (e.g., SFN #1), 10 dBm in a second period (e.g., SFN #3), and so on up to a peak power level. The different time instances when an SSB may be transmitted from the lowest to the highest transmit power or the highest to lowest transmit power may correspond to a power incrementing cycle or a power decrementing cycle, respectively. In some embodiments, a reference SSB may not be configured for this pattern.

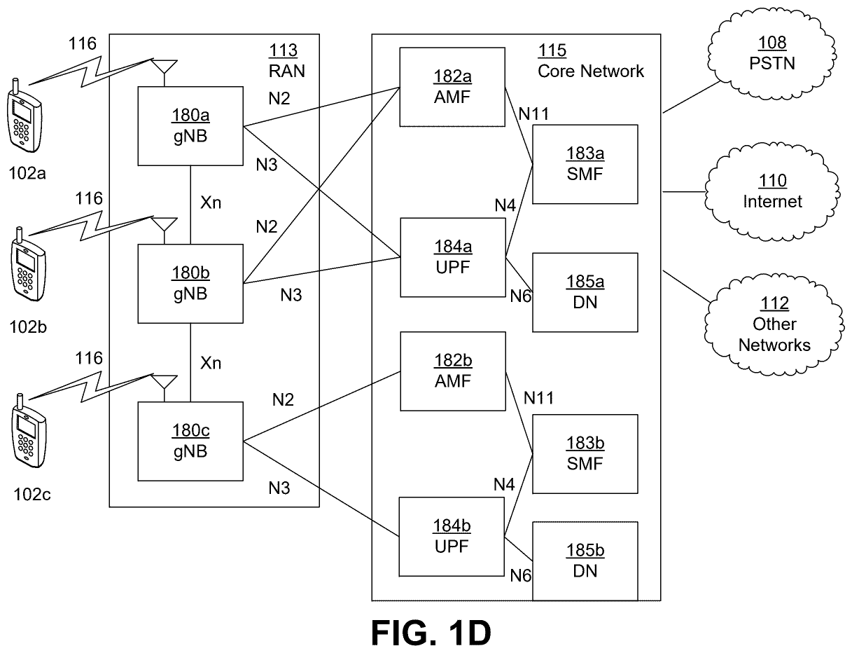

FIG. 4 is a timing and power diagram illustrating examples of SSB power patterns, according to one or more embodiments of the present disclosure. In FIG. 4, SSB bursts may be transmitted with a (e.g., respective) SSB burst periodicity. For a first power pattern (e.g., Power Pattern 1), a uniform (e.g., same) transmit power may be applied for all SSBs (e.g., of each SSB burst). For a second power pattern (e.g., Power Pattern 2), a non-uniform transmission power may be applied per SSB (e.g., of each SSB burst). The transmission power may be determined with reference to a power offset value. A reference SSB (e.g., in each SSB burst) may use a peak power. The reference SSB may be fixed (e.g., the same) in each SSB burst. For a third power pattern (e.g., Power Pattern 3), a non-uniform transmission power may be applied per SSB (e.g., of each SSB burst). The reference SSB (e.g., in each SSB burst) may use a peak power. The reference SSB may be variable (e.g., different) in each SSB burst. For a fourth power pattern (e.g., Power Pattern 4), a non-uniform transmission power may be applied per SSB (e.g., of each SSB burst). The transmission power may be determined with reference to a power offset value. The transmission power may change for each SSB (e.g., of each SSB burst). In other examples, the power patterns shown in FIG. 4 may be modified and/or combined.

For example, a (e.g., any) of the SSB power adaptation patterns may be identified by an index or other identifier. The parameters associated with SSB and/or RS power patterns (e.g., power offsets, reference SSB) may be configured and/or indicated with the power adaptation patterns. For example, a WTRU 102 may receive configuration information (e.g., in RRC, DCI) containing a set of parameters that may be associated with a power adaptation pattern. As another example, the parameters may be configured and/or indicated separately from the power adaptation patterns. In this case, when configured and/or indicated separately, the WTRU 102 may determine an SSB power pattern based on the parameters.

In some embodiments, a WTRU 102 may be configured with at least one power adaptation pattern as a default pattern. The WTRU 102 may assume the default power pattern may be active and/or applicable when no other power patterns are configured, indicated or activated, for example. As another example, when an ongoing power pattern is deactivated and/or a new power pattern is not indicated, the WTRU 102 may assume the network uses the default power pattern.

In some embodiments, a (e.g., any) SSB and/or RS power pattern may be associated with one or more NES states and/or modes. For example, when the network operates in a sleep mode or a spatial domain (SD) adaptation mode (e.g., where a subset of antenna ports may be powered off), the SSBs may be transmitted with a particular power adaptation pattern (e.g., Pattern 3). For example, when operating in a fully active mode, the SSBs may be transmitted with another pattern (e.g., Pattern 1).

For example, a WTRU 102 may receive information indicating one or more (e.g., a set of) parameters for beam selection.

For example, a WTRU 102 may be configured with one or more (e.g., a set of) threshold values associated with any of RSRP measurements and pathloss estimation, such as for selecting one or more usable SSB and/or RS beams (e.g., when performing beam (re) selection, cell/beam ranking, PRACH transmission).

The threshold values may be configured and/or indicated on the basis of any of per beam, per burst, per (sub-)configuration, and/or per cell. For example, when configured on a per beam basis, one or more SSB beams in a burst may be associated with at least one RSRP threshold value. A WTRU 102 may select an SSB beam (e.g. before/during RACH), when the corresponding RSRP measurement is greater than or equal to its (e.g., respective) RSRP threshold value.

In an example of 4 SSB beams in a burst, a reference SSB (e.g., SSB #2) may correspond to an SSB that may be transmitted with a peak transmit power. The WTRU 102 may be configured with at least one RSRP threshold that may be applicable for the reference SSB (e.g., Ref_RSRP_Th). The WTRU 102 may also be configured with one or more offset values associated with the RSRP thresholds for other SSBs (e.g., relative offsets). The offset values may be relative to the difference with respect to the threshold configured for the reference SSB. For example, for the first SSB (e.g., SSB #0), the second SSB (e.g., SSB #1) and the fourth SSB (e.g., SSB #3), the offset values may correspond to first, second and third offsets (e.g., offset #1, offset #2 and offset #3). As an example, the WTRU 102 may determine the corresponding RSRP thresholds for the other SSBs as Ref_RSRP_Th-offset #1, Ref_RSRP_Th-offset #2 and Ref_RSRP_Th-offset #3, respectively. As another example, the per beam offset values for RSRP thresholds may be configured using the peak transmit power as the reference.

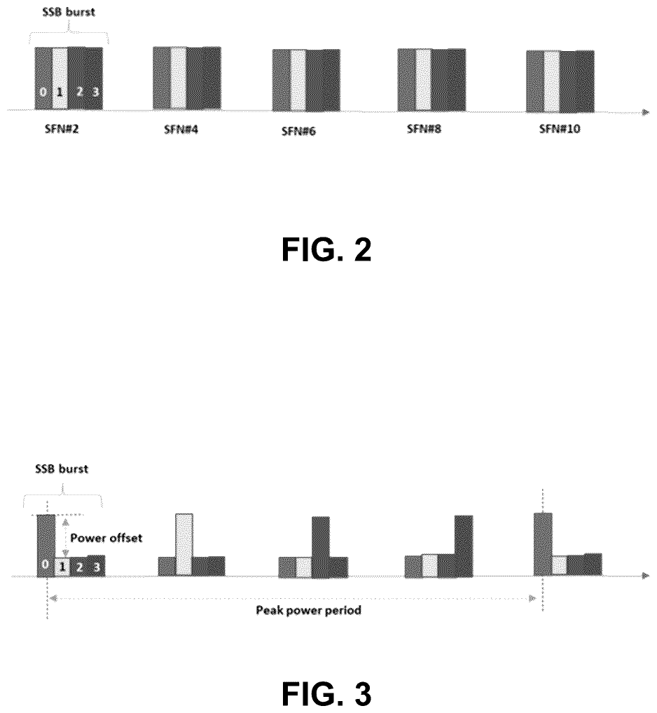

FIG. 5 is a timing and power diagram illustrating examples measurement thresholds for an example SSB burst, according to one or more embodiments of the present disclosure. As shown in FIG. 5, an SSB #2 may be configured, indicated, or otherwise determined as a reference SSB of a SSB burst. The SSB #2 may use a peak transmit power. The SSB #2 may be associated with a measurement threshold (e.g., RSRP_Th). This measurement threshold may be reference SSB-specific. For other SSBs of the SSB burst, such as SSB #0, SSB #1 and SSB #3, these SSBs may be associated with respective measurement thresholds, which are relative to the threshold associated with the reference beam. For example, a RSRP_Th for SSB #0 may be determined based on the measurement threshold for the reference beam and a first offset value (e.g., Offset #1). For example, a RSRP_Th for SSB #1 may be determined based on the measurement threshold for the reference beam and a second offset value (e.g., Offset #2). For example, a RSRP_Th for SSB #3 may be determined based on the measurement threshold for the reference beam and a third offset value (e.g., Offset #3).

In certain representative embodiments, a similar set of parameters (e.g., reference threshold and offsets) may be configured for pathloss estimation when the criterion applied for beam selection is based on pathloss.

For example, a WTRU 102 may receive information indicating an application time and/or delay time. The WTRU 102 may be configured with one or more (e.g., a set of) application time and/or delay values (e.g., time offset or gap), which may indicate a time duration starting from a reference time instance, such as the time instance (e.g., symbol and/or slot) from the reception of an indication indicating an SSB and/or RS power adaptation pattern to the time instance when the actual SSB and/or RS with power adaptation pattern may be available (e.g., the time instance the WTRU 102 receives an SSB with the actual adapted power). As another example, the application time and/or delay may indicate a time duration starting with a time instance from the reception of an indication during a first power adaptation pattern to the time instance when a second power adaptation pattern may become available.

For example, a WTRU 102 may receive information indicating one or more frequency bands and/or control resources associated with SSB and/or RS beams with power adaptation. The WTRU 102 may be configured with any of the frequency band and/or BWP information and/or synchronization raster information (e.g., an index or identifier of the synchronization raster where the SSB and/or RS beams may be located) where the SSB and/or RS beams with power adaptation may be received. The WTRU 102 may be configured with any of CORESET, SS, and/or PDCCH monitoring configurations in which any of the control indications associated with SSB and/or RS power adaptation may be received. For example, when the frequency resources for the SSBs before power domain adaptation (e.g., a first power adaptation pattern) and after power domain adaptation (e.g., second power domain pattern) may be located in different bands, channels, and/or BWPs, the WTRU 102 may switch to an associated band, channel, and/or BWP for receiving the SSBs with the corresponding power adaptation. The WTRU 102 may also switch from a first CORESET, SS, and/or PDCCH monitoring configuration associated with an existing SSB power pattern to a second CORESET, SS, and/or PDCCH monitoring configuration associated with another SSB power pattern, during adaptation of the SSB power pattern, for example.

For example, a WTRU 102 may receive information indicating validity information associated with SSB power adaptation. The WTRU 102 may be configured validity information associated with the power adaptation of SSB and/or RS beams. Such validity information may be associated with any of time, location, and/or spatial attributes. For example, a time validity may indicate the time duration (e.g., in terms of symbols, slots, SFNs) during which any of the SSB power patterns may be assumed to be valid. After the end or expiry of the time duration (e.g., timer), the WTRU 102 may assume the (e.g., SS) power pattern is no longer available, valid, and/or switch to another SSB power pattern (e.g., a default pattern). As another example, a location validity may indicate the coverage area or location, such as associated with a WTRU 102 location and/or a cell identity, in which any of the SSB power patterns may be assumed to be valid. Outside of the location validity, the WTRU 102 may assume the SSB power pattern may no longer be available or valid, for example.

For example, a WTRU 102 may receive information indicating one or more (e.g., a set of) NES states and/or modes. The WTRU 102 may be configured with information indicating an association between NES states and/or modes and the SSB and/or RS power adaptation patterns. For example, when configured, or indicated, with cell DTX (e.g., certain periodically occurring active and non-active periods) the WTRU 102 may apply a first power adaptation pattern (e.g., uniform transmit power for beams in a burst) during the cell DTX active periods and a second power adaptation pattern (e.g., non-uniform transmit power for beams in a burst) may be applied during the cell DTX non-active periods or when the cell DTX mode is deactivated. As another example, a first set of SSB and/or RS beams may be transmitted with a first power level in one or more (e.g., a first set of) symbols, slots, periods, and/or SFNs and a second set of SSB and/or RS beams may be transmitted with a second power level in one or more other (e.g., a second set of) symbols, slots, periods, and/or SFNs.

In certain representative embodiments, a WTRU 102 may receive indication(s) associated with SSB and/or RS beam power adaptation.

In certain representative embodiments, a WTRU 102 may receive one or more explicit and/or implicit indications from the network associated with SSB/RS transmission parameters and/or patterns and power adaptation (e.g., parameters, values) that may be applied to one or more SSB/RS beams. A WTRU 102 may receive one or more indications in any of the following.

For example, one or more indications may be received via SI and/or RRC signaling. An indication may be received in any (e.g., dedicated) RRC messages for the WTRU 102 in CONNECTED and/or INACTIVE modes. An indication may be received in broadcast messages (e.g. PBCH payload, MIB, SIB1, SIBx) for a WTRU 102 in CONNECTED, IDLE, and/or inactive modes.

When one or more indications are received in a PBCH payload and/or MIB, the indications may be received in any of the bit-fields associated with a SFN, a SSB subcarrier offset (e.g., K_SSB), PDCCH configuration (e.g., for SIB1/x), a SSB index, spare bits, reserved bits, CRC bits (e.g., by scrambling power adaptation parameters). As another example, a new bit-field may be configured for indicating any values of the SSB/RS transmission and power adaptation parameters. For example, one or more parameter values, such as peak SSB power and/or SSB burst periodicity, may be indicated as additional bits in the bit-fields associated with a PDCCH configuration for SIB1, reserved bits, or a new bit-field. When indicating in the PDCCH configuration bit-field, additional rows and/or columns may be included in the associated tables for indicating the parameter values for SSB/RS transmission parameters, patterns, and/or power adaptation parameters, for example. As another example, at least a subset of bits in any of the bit-fields (e.g., PDCCH configuration) may be repurposed for indicating SSB/RS related parameters. In examples, a subset of the bits associated with the SSB transmission and/or power adaptation parameters may be indicated in a bit-field of a MIB and another subset of bits in the same or different bit-field of the PBCH payload.

As an example, the type of SSBs transmitted may include cell defining SSBs (e.g., CD-SSBs), which may include an associated SIB1, the SSB/RS power adaptation parameters may be provided in the SIB1, such as in combination with other (e.g., existing) SSB transmission parameters (e.g., SSB positions in burst, SSB periodicity). As another example, the power adaptation parameter values may be provided in another SIB (e.g., SIBx).

As an example, the type of SSBs transmitted may include non-cell defining SSBs (e.g., NCD-SSBs), which may not include an associated SIB1, and the SSB/RS parameters for transmission pattern and/or power adaptation may be provided in a separate SIB (e.g., SIBx or a new SIB) that may be transmitted in the same or different time and/or frequency resources where the SIB1 may be transmitted. For example, a pre-SIB1 may be transmitted containing the SSB/RS parameters in an earlier set of resources than the resources used for SIB1.

For example, one or more indications may be received via L2 signaling. An indication may be received in a MAC CE or any access stratum (AS) layer signaling, such as PDCP or RLC control PDU(s). As an example, a (e.g., DL) MAC CE may be configured with a set of bit-fields to indicate one or more values of the parameters associated with SSB/RS transmission and/or power adaptation. The WTRU 102 may be configured (e.g., via RRC) with multiple values of SSB/RS power adaptation parameters (e.g., indexes of power adaptation patterns and/or values of power offset per SSB) and the MAC CE may indicate in a bit-field one of the configured values. For example, in the case when there may be 4 active SSBs, the power offset per SSB may be indicated in a bit string. An example bit string may comprise 8 bits with 2 bits per SSB index that may indicate one of 4 power offset values per SSB index.

For example, one or more indications may be received via L1 signaling. An indication may be received in DCI, including in any of scheduling/non-scheduling DCI formats, new DCI formats (e.g., encoded with a NES-RNTI), system information DCI (e.g., in CORESET-0 and/or SS-0, such as may be encoded with SI-RNTI), a TCI state indication, a measurement related DCI (e.g., aperiodic CSI), a paging DCI (e.g., encoded with P-RNTI, PEI-RNTI), wake-up signaling (e.g., WUS, LP-WUS).

Any of the SSB/RS transmission and/or power adaptation parameters may be received in one or more cell-common DCIs or group-common DCIs (e.g., encoded with SI-RNTI or a new RNTI) in common search spaces (CSSs) or received in UE-specific DCIs in UE search spaces (USSs). In examples, where the SSB parameters may be provided during cell (re) selection, initial access or SI update, the WTRU 102 may receive the DCI indicating such parameters in resources associated with CORESET-0 and/or SS-0 or in another CORESET-x and/or SS-x. Such CORESET and/or SS resources for receiving the DCI may be predefined or provided in a PBCH payload or MIB, for example.

In an example, the DCI may indicate the values associated with any of the SSB/RS parameters (e.g., in preconfigured bit-fields in a DCI format). In another example, the DCI may indicate indexes to one or more SSB/RS patterns (e.g., SSB/RS transmission patterns and/or power adaptation patterns) which may be associated with a set of predefined or preconfigured tables, or rows in tables, that may indicate the values of the SSB/RS parameters.

In certain representative embodiments, the parameters and/or values associated with any of the SSB/RS transmission and power adaptations may be received by a WTRU 102 in standalone signaling (e.g., MIB-only, SIB-only, DCI-only) or in a combination of multiple signaling (e.g., 2-stage indications). In the case of multi-stage signaling, a subset of parameters may be received in a first type of signaling (e.g., PBCH payload/MIB) and another subset may be received in a second type of signaling (e.g., GC-DCI). Further examples of multi-stage signaling are as follows.

For example, a WTRU 102 may receive multi-stage signaling via at least (i) a PBCH payload or MIB and (ii) a SIB (e.g., SIB1). The PBCH payload and/or MIB may indicate the time/frequency resources for receiving the PDCCH associated with SIB1. For example, the resources for receiving a PDCCH (e.g., CORESET-0 and/or SS-0, CORESET-x and/or SS-x) may be indicated in the bit-field associated with a PDCCH configuration for the SIB (e.g., SIB1, SIBx). The SSB/RS parameters (e.g., transmission pattern and/or power adaptation patterns) may then be indicated in the SIB (e.g., SIB1, SIBx), which the WTRU 102 determines upon receiving the associated DCI in PDCCH (e.g., encoded with SI-RNTI or NES-RNTI). As another example, the PBCH payload or MIB may indicate a first set of parameters (e.g., SSB positions in a burst and a peak SSB power). The SIB may indicate a second set of parameters (e.g., SSB power pattern, start offset, power offset). Such indications in MIBs and SIBs may be received before the WTRU 102 performs cell (re) selection or initial access with a cell and/or during SI update, such as where the WTRU 102 may monitor for an update of any SSB/RS parameters according to a configured periodicity.

For example, a WTRU 102 may receive multi-stage signaling via at least (i) a PSS and/or SSS and (ii) a MIB and/or SIB (e.g., SIB1). A combination of PSS and/or SSS signals may indicate the values of a first set of parameters (e.g., peak SSB power) and the MIB and/or SIB may indicate values of a second set of parameters (e.g., SSB power offset). When using a PSS and/or a SSS, the parameter values may be encoded into the sequences associated with the signals (e.g., by scrambling the values on the sequences).

For example, a WTRU 102 may receive multi-stage signaling via at least (i) a SIB (e.g., SIB1 and/or SIBx) and (ii) DCI. A SIB1 may indicate any of the semi-static SSB/RS parameters (e.g., SSB periodicity, SSB positions in burst, peak power) and a DCI may indicate any dynamic SSB/RS parameters (e.g., power pattern, power offset/adjustment). The DCI may indicate the values associated with the parameters (e.g., in preconfigured bit-fields) or may indicate indexes to one or more SSB/RS patterns (e.g., SSB/RS transmission and/or power adaptation pattern) which may be associated with predefined or preconfigured tables, or rows in tables, that may indicate the SSB/RS parameters. Such indications in SIB1 and DCI may be received during cell (re) selection (e.g., the DCI may be encoded with a SI-RNTI or new RNTI) and/or when the WTRU 102 is in IDLE and/or INACTIVE mode. Such DCI may be received in any of a GC-DCI (e.g., encoded with SI-RNTI, NES-RNTI, new RNTI), a paging DCI (e.g., encoding with P-DCI, PEI-DCI) and/or a wake-up signal. As another example, when the WTRU 102 is in CONNECTED mode, such DCI may be received in a GC-DCI (e.g., encoded with NES-RNTI, cellDTXDRX-RNTI) and/or any scheduling or non-scheduling UE-specific DCIs (e.g., encoded with C-RNTI).

For example, a WTRU 102 may receive multi-stage signaling via at least (i) a PBCH payload or MIB and (ii) DCI. A PBCH payload or MIB (e.g., in any of reserved, repurposed or new bit-fields) may indicate any of the semi-static SSB/RS parameters (e.g., SSB periodicity, SSB positions in burst, peak power) and a DCI may indicate any dynamic SSB/RS parameters (e.g., power pattern, power offset/adjustment). For example, a first power offset value (e.g., a power offset from a peak value or power offset per burst) may be received in the PBCH payload or MIB and a second power offset value (e.g., power offset adjustment per SSB) may be received in the DCI. As another example, the PBCH payload or MIB may indicate the CORESET-x and/or SS-x (e.g., resources) for receiving a PDCCH and the DCI received in the PDCCH may indicate the SSB/RS parameters. Indications in the PBCH payload or MIB and DCI may be received during cell (re) selection and/or when the WTRU 102 is in IDLE and/or INACTIVE mode. As another example, DCI may be received in or as a GC-DCI or any scheduling or non-scheduling UE-specific DCIs (e.g., encoded with C-RNTI), such as when the WTRU 102 is in CONNECTED mode.

For example, a WTRU 102 may receive multi-stage signaling via at least (i) a MAC CE and a (ii) DCI. A MAC CE may indicate a set of SSB/RS parameters (e.g., SSB periodicity, SSB positions in burst, SSB power offset/adjustment), where such parameters may correspond to a candidate set that may be applicable during SSB/RS transmission. A DCI may indicate a particular value among the candidate set for one or more SSB/RS parameters. As another example, a MAC CE may indicate the values of one or more SSB/RS parameters, which may be associated with an SSB/RS pattern, and the DCI may indicate the activation and/or deactivation of the associated SSB/RS pattern. Similarly, the MAC CE may indicate the activation and/or deactivation of one or more SSB/RS patterns and the DCI may indicate any new or updates to the SSB/RS parameter values, for example.

For example, a WTRU 102 may receive multi-stage signaling via at least (i) a first DCI and (ii) a second DCI. A first DCI may indicate a first set of SSB/RS parameters (e.g., SSB periodicity, SSB positions in burst, peak power) and a second DCI may indicate a second set of SSB/RS parameters (e.g., power pattern, power offset/adjustment). The first DCI may correspond to a GC-DCI and the second DCI may correspond to a UE-specific DCI, for example.

In certain representative embodiments, any of the one or more indications associated with SSB/RS transmission and/or power adaptation may be received from a same cell or base station in which such transmission and/or power adaptation patterns may be applicable. In other embodiments, such as in multi-cell deployments, the indications associated with one cell (e.g., a NES cell) may be received from another cell (e.g., an anchor cell). For example, the SSB transmission and/or power adaptation parameters of an NES cell may be received in any of SIBx, L2, and/or L1 signaling of an anchor cell. In this case, a WTRU 102 may receive indexes or other identifiers associated with the one or more NES cells when receiving any associated indications related to SSB/RS transmission and power adaptations from an anchor cell.

In certain representative embodiments, information associated with SSB/RS power adaptation may be included in received indications. The indications received by a WTRU 102 associated with SSB/RS transmission and SSB/RS beam power adaptation may indicate and/or contain a combination of any of the following.

For example, a WTRU 102 may receive at least one indication of SSB/RS beam power adaptations. Such indications may indicate the indexes or other identifiers of any of the SSB/RS transmission patterns and/or beam power adaptation patterns. For example, such indications may indicate the activation and/or deactivation status of the SSB/RS patterns (e.g., a pattern that is enabled and/or a pattern that is disabled). Such indications may indicate the patterns at a per beam level (e.g., wide-beam) or per sub-beam level (e.g., narrow-beam which may be associated with a wide-beam) for which certain parameters (e.g., power offset/adjustment) may be applicable. For example, an indication may indicate a particular power offset value (e.g., 2 dB) may be applied to a subset of active SSBs. Such an indication may be received in a bitmap that is associated with the power offset value (e.g., a bit of ‘1’ in the bitmap may indicate the power offset is applied to the corresponding SSB index).

For example, the indications may indicate the parameters and/or values associated with any of the SSB/RS transmission patterns and/or beam power adaptation patterns. As an example, the parameters of the transmission patterns may correspond to any of those in the time domain, frequency domain, and/or spatial domain for providing the candidate locations of the SSB/RS beams (e.g. SFN index, half-frame index, start offset SFN, burst periodicity, SSB positions in burst). Such information may be used by the WTRU 102 for identifying the time, frequency, and/or spatial locations of the SSB/RS beams. As another example, the parameters of power adaptation may correspond to the transmit power of one or more SSB/RS beams (e.g., peak SSB power, such as per burst), reference SSB/RS, power offset/adjustment, such as per SSB, and/or peak power periodicity).

For example, a WTRU 102 may receive at least one indication for enabling and/or disabling, or activation and/or deactivation, of one or more SSB/RS (sub-)configurations. An indication for SSB/RS (sub-)configurations may be associated with any of SSB transmission patterns and SSB power adaptation patterns, and a subset of SSB/RS beams (e.g. beams allowed/preconfigured for power adaptation). An indication for SSB/RS (sub-)configurations may be associated with any of periodic, semi-persistent, aperiodic, and/or on-demand SSB/RS. For example, periodic RS configurations may be triggered with RRC signalling. A subset of parameters (e.g., power offset) associated with the RS configurations may be indicated and/or updated with dynamic signalling (e.g., MAC CE and/or DCI).

For example, an indication on the (de) activation of SSB/RS (sub-)configurations may be received in a bitmap format, such as using a certain configured length corresponding to the number of configured SSB/RS (sub-)configurations or SSB beams, where a bit of ‘1’ in the bitmap may indicate the activation of an SSB (sub-)configuration and/or beam and a bit of ‘0’ may indicate deactivation of an SSB (sub-)configuration and/or beam.

When receiving an activation indication, a WTRU 102 may assume the resources associated with the activated SSB/RS (sub-)configuration are usable, such as for measurements. The WTRU 102 may assume the resources in the activated SSB/RS (sub-)configuration may be used for measurements immediately, after a certain application time (e.g., the duration may be configured or indicated), or after receiving another triggering indication, for example.

When receiving a deactivation indication, a WTRU 102 may assume the resources associated with the deactivated SSB/RS (sub-)configuration are not usable for measurements. The WTRU 102 may assume the resources in the deactivated SSB/RS (sub-)configuration may be unused for measurements immediately, or after a certain application time (e.g., configured or indicated), for example.

As an example, the WTRU 102 may switch from a first set of one or more SSB/RS (sub-) configuration to a second set of SSB/RS (sub-)configurations when receiving a switching indication (e.g., indicating to switch to another set of indexes or identifiers associated with SSB/RS (sub-)configuration) or a deactivation indication. The indication on SSB/RS (sub-)configuration may include information on new or updated parameters associated with the configurations. For example, the indication may indicate a set of new resources and/or beams (e.g., in time, frequency, spatial domain) for one or more SSB/RS (sub-)configuration, such as where power adaptation may be applicable.

As another example, an indication may indicate a new resource and/or TCI pool from which the WTRU 102 may select the resources for one or more SSB/RS (sub-)configurations. When receiving new or updated parameters, the indication may include the index or other identifier of the SSB/RS (sub-)configuration for which the new or updated parameters may be applicable or not applicable, for example.

For example, a WTRU 102 may receive at least one indication for a change of property of a set of SSB/RS beams. An indication may indicate, such as for a set of SSB/RS beams, the status of power adaption from ‘not allowed’ to ‘allowed’, and vice-versa. When power adaptation is not allowed, the WTRU 102 may assume the transmit power of the associated SSBs are fixed and not adaptable, for example. When power adaptation is allowed, the WTRU 102 may assume the transmit power of the associated SSBs may be updated (e.g., with a configured or indicated power offset and/or adjustment value). An indication may indicate a set of SSB/RS beams (e.g., legacy and/or 5G beams) is replaced by another set of SSB/RS beams (e.g., new and/or 6G beams).

For example, a WTRU 102 may receive at least one indication for parameters associated with a set of SSB/RS beams. Indications may indicate the parameters and/or values associated with any of the SSB/RS transmission and beam power adaptations. Such parameters may not be associated with any of the predefined and/or preconfigured transmission patterns and power adaptation patterns. For example, the parameters of SSB transmission may include any of SFN index, half-frame index, start offset SFN, burst periodicity, SSB positions in burst, and the like. For example, the parameters of power adaptation may include peak SSB power (e.g., per burst), reference SSB/RS, power offset/adjustment (e.g., per SSB), and/or peak power periodicity. Such power related parameter values may be provided in absolute units or relative units (e.g., with respect to reference values).

For example, a WTRU 102 may receive at least one indication of a start and/or end of SSB/RS transmission and power adaptation. For example, an indication may include the timeline or timing information (e.g., in terms of absolute time symbols, slots, or ms, or relative time with respect to reference symbols, slots, or ms) for the transmission and/or power adaptation of the associated SSB/RS beams (e.g., the expected timing for the WTRU 102 for receiving SSB beams with adapted power). For example, the timing information may be indicated on the basis of per SSB/RS (sub-)configuration, per burst, and/or per SSB/RS beam. In another example, the indication may include the timing information for ending or stopping SSB/RS beam transmission, such as with power adaptation. Such an indication may provide the length or duration of time (e.g., a max number of symbols, slots, ms) for completing SSB/RS beam transmission that may be no later than a time window. Such indications on SSB/RS beam transmission may be received in a separate indication or in the same indication as that of a (de) activation of SSB/RS (sub-) configurations.

For example, a WTRU 102 may receive at least one indication signalling the enabling and/or disabling, or activation and/or deactivation, of TCI states. Such an indication may correspond to a set, pool, and/or candidate of TCI states (e.g., preconfigured in the WTRU). A set and/or pool of TCI states may be those associated with one or more SSB/RS beams that may be grouped based on power adaptation parameters. For example, an SSB beam with a transmit power level with a first power offset and/or adjustment value may be associated with one TCI state and the same beam with a second power offset and/or adjustment value may be associated with another TCI state. When the transmit power level of an SSB beam is changed (e.g., from peak transmit power to low transmit power), the associated QCL properties, such as the QCL type, may be updated, such as via a TCI state indication.

When a TCI state is activated, the WTRU 102 may assume one or more of the parameters associated with the TCI state (e.g., QCL source, QCL type, and/or SSB/RS beam) are valid until the conditions invalidating the TCI state are met (e.g., expiry of a validity interval or timer, reception of a deactivation indication). Such an indication may or may not be associated with the TCI states associated with the SSB/RS beam (sub-)configurations. For example, the indication may indicate the activation and/or deactivation status of a pool or list of TCI states, a subset of which may be associated with one or more SSB/RS beam (sub-)configurations and another subset of which may not be associated with the SSB/RS beam (sub-)configurations. Such an indication may be received in a bitmap format, such as with a certain configured length corresponding to the number of configured TCI states, where a bit of ‘1’ in the bitmap may indicate the activation of a TCI state and a bit of ‘0’ may indicate deactivation of a TCI state.

The signalling of an indication associated with TCI states may be received on the basis of per TCI state, per cell, per carrier, per SSB/RS configuration, per SSB/RS sub-configuration, and/or per SSB/RS beam. In an example, an indication on TCI states may be received as part (e.g., in a bit-field) of another indication associated with any of (de) activation of SSB/RS (sub-) configurations, NES adaptation and/or state, and/or cell activity. In another example, the WTRU 102 may switch from a first set of one or more TCI states to a second set of TCI states when receiving a switching indication (e.g., an index or other identifier indicating to switch to another set of TCI states) or a deactivation indication.

For example, a WTRU 102 may receive at least one indication signalling the enabling and/or disabling, or activation and/or deactivation, of NES adaptations and/or states. Such an indication may indicate the NES adaptation schemes (e.g., indexes or other identifiers) such as SD and/or PD adaptations and cell DTX and/or DRX, based on which the WTRU 102 may determine or identify the associated SSB transmission patterns, SSB/RS beam power adaptation patterns, and/or SSB/RS configurations, for example. For example, any of the SSB/RS beam power adaptation patterns may be applied upon receiving a NES state activation indication. When receiving a NES state deactivation indication, the SSB/RS beam power may be transitioned to a default pattern. In an example, the indication may include the timing information (e.g., in terms of absolute time symbols, slots, or ms or relative time with respect to reference symbols, slots, ms) indicating when the NES adaptation is (e.g., expected) to start and/or end.

In certain representative embodiments, a WTRU 102 may determine and/or perform certain actions and/or behaviors upon receiving an indication associated with SSB power patterns. In some embodiments, the WTRU 102 may perform one or more actions upon configuration and/or reception of indications from the network on any of SSB/RS beam transmission and/or power adaptations.

### SSB/RS Beam Determination

In certain representative embodiments, a WTRU 102 may determine SSB/RS beams with power adaptation

In certain representative embodiments, a WTRU 102 may, upon receiving one or more configurations and/or indications associated with SSB power adaptations (e.g., a change and/or adjustment to per-beam transmit power level), determine and/or select one or more SSB/RS beams, such as for measurements, based on the indicated parameters (e.g., power pattern, peak transmit power, power offset). A benefit of such indications, which may be received dynamically, is that the transmit power of one or more SSB/RS beams may be dynamically updated without having to reconfigure (e.g., all) applicable associated parameters.

For example, a WTRU 102 may determine or select the SSBs based on the information indicating an association between the parameters and time domain location(s) of the SSBs. Since the SSB power may change from one burst to another, such as according to a power adaptation pattern, the WTRU 102 may determine the SSBs (e.g., for measurements) across multiple bursts (e.g., at least 2 consecutive or non-consecutive bursts). In an example, the WTRU 102 may receive indications on the set of active SSBs in one or more bursts (e.g., via a SSB positions in a burst parameter), such as in combination with other SSB power related parameters. In this case, the WTRU 102 may determine the transmit power of each active SSB within a burst based on the peak power (e.g., the transmit power used for a reference beam) and the per-beam power offset values, for example.

For determining the transmit power of an SSB in a particular burst across multiple bursts, the WTRU 102 may determine the association between the transmit power of SSBs (e.g., per burst) and time domain locations of the SSB bursts based on the power adaptation parameters (e.g., a start offset burst/SSB of power pattern, power offset per beam, step-size change in power offset, and/or periodicity of power pattern) and the SSB/RS transmission pattern and/or configuration parameters (e.g., a SFN index indicating even or odd SFNs for candidate SSB bursts, a half-frame index indicating first or second half of an SFN, a SSB burst periodicity). Such power adaptation parameters and SSB/RS transmission parameters may be used for determining the power-time association when any of the associated patterns are not indicated. When the patterns are indicated, a similar approach may be used for determining the transmit power of each active SSB across multiple bursts, based on any of power adaptation pattern (e.g., index or other identifier of the pattern), reference SSB/RS per burst, and step-size change in power offset per burst. In the case when at least a subset of the SSB power adaptation parameters is not indicated, the WTRU 102 may autonomously derive the parameters based on configuration and/or indication of transmission pattern parameters and measurements over a time window (e.g., N bursts/periods), that may be predefined and/or preconfigured. For example, the WTRU 102 may derive the power offset of an SSB index and correspondingly the power adaptation pattern for the SSB index based on measurements of the RSRP change from one period during measurements performed over N periods in the window. By applying the same spatial receive filter associated with the SSB index during measurements, the WTRU 102 may determine the power offset applied in each per period relative to the peak transmit power when transmitting the SSB. In the case when the reference SSB/RS is transmitted with the peak transmit power and other SSBs are transmitted with reduced power (e.g., with a per beam power offset), the WTRU 102 may derive the power offset values for the other SSBs based on the RSRP measurements made on the reference SSB/RS and the other SSBs.

For example, a WTRU 102 may determine or select a set of target SSBs (e.g., for measurements) in a subset of SSB bursts from multiple SSB bursts and/or periods based on the power adaptation parameters. In an example, the WTRU 102 may determine a subset of SSB bursts (e.g., only) when the target SSBs are transmitted with a certain transmit power level (e.g., peak power, peak power+power offset X). For example, the WTRU 102 may perform measurements of SSB #0 and SSB #1 when these SSBs are transmitted in period #4, period #7 and period #9 when the corresponding transmit power levels of these SSBs are above a particular transmit power threshold value. The WTRU 102 may send one or more indications to the network, such as upon determining or selecting any of the SSB/RS beams. Such indications may indicate the information associated with the selected beams (e.g., beam index), bursts, and/or configurations. Such indications may be sent in any of L3 (e.g., RRC), L2 (e.g., MAC CE), and/or L1 (e.g., UCI) signaling.

### SSB/RS Beam Measurement

In certain representative embodiments, a WTRU 102 may perform measurements of SSB/RS beams with power adaptation.

For example, a WTRU 102 may perform measurements of the one or more determined or selected SSB/RS beams, which may be subject to power adaptation, in one or more periods. Such measurement periods may correspond to the time domain locations in which the candidate SSB/RS bursts are expected to be transmitted according to an SSB/RS transmission pattern and/or configuration. Such measurement periods may correspond to any of one or more SFNs, half-frames, subframes, bursts, slots, and/or symbols. Such measurements made by the WTRU 102 may include any of L3, L2, L1 measurements (e.g., of EPRE, RSRP, RSSI, RSRQ). The WTRU 102 may perform measurements of at least one active SSB in a burst over one or more periods, in which case the RSRP may change in different periods due to changes in SSB transmit power.

For example, a WTRU 102 may send indications and/or measurements to the network, such as when one or more certain measurement criteria associated with the SSB/RS beam power adaptation are met. For example, such criteria may include RSRP of the SSB/RS beam subject to power adaptation being above, or below, a threshold value and a RSRP change or difference between the same set of SSB/RS beams across one or more bursts or periods being above, or below, a threshold value. Similar criteria may be applied when the corresponding configured thresholds are associated with pathloss estimation (e.g., pathloss threshold, pathloss change threshold). For example, the WTRU 102 may perform pathloss estimation of an SSB/RS beam with power adaptation based on the peak transmit power applied to the associated SSB beams (e.g., active SSBs in burst), per beam power offset and/or adjustment and the RSRP measurement of the SSB beam. In this case, the measurement criteria may be met when a pathloss of the SSB/RS beam subject to power adaptation is above, or below, a pathloss threshold value and a pathloss change or difference between the same set of SSB/RS beams across one or more bursts or periods is above, or below, a pathloss change threshold value. The pathloss threshold values (e.g., per beam level, per burst level, per configuration level, and/or per cell level) may be configured and/or indicated to be either absolute values or relative values (e.g., offset with respect to a reference pathloss threshold, such as for a reference beam).

For example, when any measurement criterion or criteria is not met (e.g., the RSRP change is above a threshold), the WTRU 102 may send a failure indication and/or information associated with the measurements. In another example, the WTRU 102 may send indications, such as in L2 (e.g., MAC CE) and/or L1 signaling (e.g., RACH, SR, WUS, and/or UCI), indicating the WTRU 102 is unable to measure the SSB/RS (e.g., when the measurement criterion is not met). The WTRU 102 may also send a request indication to the network to change and/or update the transmit power of the SSB/RS beams, such as where the measurement criteria are not met, for example. As another example, when any measurement criterion or criteria is not met and/or when the measurements made exceed the configured RSRP/pathloss thresholds by a certain margin, the WTRU 102 may send a request indication to the network to power off or reduce the transmit power of the SSB/RS beams. In another example, the WTRU 102 may determine and indicate (e.g., report) the lowest transmit/Rx power that may achieve a configured target (e.g., RSRP, RSRQ, pathloss) value. The lowest transmit/Rx power may be associated with improving NES performance, for example. Such indications may be sent on the basis of per beam, per burst, per (sub-)configuration, and/or per cell in any of L3, L2 and/or L1 signaling.

### Beam Selection

In certain representative embodiments, a WTRU 102 may perform beam selection (e.g., of a best beam(s)) among (e.g., measured) SSB/RS beams.

In certain representative embodiments, a WTRU 102 may determine a (e.g., best) beam among the measured SSB/RS beams based on any of the received indications and/or measurements. The measured SSB/RS beams may be part of a candidate list of SSBs that may be ranked and/or selected by the WTRU 102. For example, the WTRU 102 may perform ranking of the SSB/RS beams based on RSRP and/or pathloss measurements and select one or more SSB/RS beams as best beam(s) from the ranked beams. For example, the WTRU 102 may determine the best one or more SSBs from the measured SSBs in one or more bursts and/or periods that is measured with a (e.g., RSRP) value that is above or equal to the configured per beam (e.g., RSRP) threshold value. When there are multiple SSB/RS beams that meet the (e.g., RSRP) threshold criteria, the WTRU 102 may select one of the beams (e.g., randomly). When configured with pathloss thresholds, the WTRU 102 may determine the best SSB from the measured SSBs in one or more bursts and/or periods that is measured with a pathloss value that is below or equal to the configured per beam pathloss threshold value. In the case when all measured SSB/RS beams are below their respective RSRP threshold values and/or above pathloss threshold values, the WTRU 102 may determine the best SSB from the set of SSBs with the highest measured RSRP value and/or lowest pathloss value.

For example, the WTRU 102 may be configured with at least one reference SSB/RS which may be transmitted with a peak transmit power (e.g., non-adapted transmit power) and other SSBs with their respective transmit power being offset (e.g., adapted transmit power). The WTRU 102 may exclude ranking and/or selecting the reference SSB/RS as the best SSB. This may apply in cases where the reference SSB/RS may be outside of the configured list of candidate SSBs that may be selected by the WTRU 102.

The WTRU 102 may perform a similar approach during cell ranking and/or cell (re) selection based upon measurement RSRP and/or estimated pathloss associated with one or more beams of a cell. The cell selection procedure may benefit from using joint conditions (e.g., criteria) based on received power levels and pathloss and may avoid the issues associated with the cases where the WTRU 102 may be located in a cell center but may try to camp on cells farther away due to the cell applying power adaptation to its SSBs. In this case, a combination of conditions (e.g., criteria) based upon received power levels and pathloss estimate may provide a better control during cell (re) selection when the WTRU 102 selects and camps on cells that apply power adaptation.

### PRACH Transmission

In certain representative embodiments, a WTRU 102 may perform a PRACH transmission using an associated or selected beam.

In certain representative embodiments, a WTRU 102 may use a (e.g., alternative) threshold for determining the best beam (e.g., an SS-RSRP threshold or RSRQ) for an initial access procedure (e.g., PRACH transmission). For example, the WTRU 102 may use a first threshold when a NES state is deactivated and a second threshold 2 when NES state is activated (e.g., the SSB is power reduced).

For example, a WTRU 102 may use a specific threshold per beam, where the WTRU 102 selects the beam and considers it as the best beam based on (e.g., only if) the measured channel condition (e.g., RSRP) is higher than a threshold configured for that specific beam. The WTRU 102 may determine a beam specific threshold by reading a configuration that indicates an offset from a default (e.g., non-NES) threshold (e.g., for peak power) or an offset from another beam in the same cell (e.g., an adjacent beam). In one example, the WTRU 102 may compare channel conditions to a first threshold when the beam is power reduced, or a second threshold when the beam is not power reduced. The WTRU 102 may use a non-default threshold (e.g., one associated with a NES state) only upon determining that the serving cell and/or beam is in a NES state or receiving signaling confirming that the cell and/or beam is in a NES state. For example, the WTRU 102 may use a threshold associated with a NES state activation only upon reception of the actual SSB transmit power (e.g., from reading system information, such as SIBs).

As an example, a WTRU 102 may include as part of a Msg3 or MsgA payload an indication that it has used a non-default or NES threshold and/or an indication about a best and/or selected beam, such as when a non-default threshold was used.

As an example, a WTRU 102 may receive a different beam selection threshold (e.g., an SS-RSRP threshold) to use during a PRACH preamble retransmission, where the threshold is indicated as part of a Msg2, a MsgB, or a back off indication. The WTRU 102 may then assume such threshold is used for one or more subsequent attempts for the serving cell and/or a certain indicated beam, where the number of attempts may be indefinite, configured, or predefined.

For example, where a plurality of beams meet the channel conditions measurement threshold (e.g., RSRP threshold), the WTRU 102 may select the beam with the highest delta from the default (e.g., non-NES) threshold, the beam with a highest channel measurement value, the beam with a highest margin above the configured threshold for that beam, and/or the beam with a largest offset from a main lobe beam.

As an example, the WTRU 102 may receive an “RSRP threshold delta” to add to an offset part of a back off indication, a RAR, or a MsgB (e.g. for preamble transmission(s)). The delta can be positive or negative, and the WTRU 102 may add it to the RSRP threshold configured for the beam and/or cell. The delta may be indicated per beam, per cell, and/or per WTRU 102). The WTRU 102 may accumulate deltas over a number of retransmissions, where for a given retransmission the WTRU 102 considers the threshold for selecting a beam as the default threshold plus all indicated deltas over the course of the procedure.

For example, the WTRU 102 may receive a backoff indication which may be specific to a certain beam(s). The WTRU 102 may then apply a configured delta or offset to the RSRP selection threshold for the indicated beam, where the offset is preconfigured and conditionally used only for when the backoff indication is received, such as for a given set of beams that are also configured. As another example, the backoff indication may indicate to the WTRU 102 that a subset of SSBs are to be used for preamble retransmissions, whereby the WTRU 102 only selects RACH occasions (ROs) associated with those indicated ones upon reception of such indication. The WTRU 102 in such cases may apply an offset to the non-indicated SSBs during the SSB selection process (e.g., to the SS-RSRP threshold), and the WTRU 102 may only select a non-indicated SSB if it is measured above the threshold plus the offset. In some cases, none of the indicated SSBs may meet the minimum quality threshold. The offset may be positive or negative.

For example, the WTRU 102 may not select a PRACH occasion or resource(s) associated with a selected SSB, if the SSB was measured with a pathloss that is under-estimated due to power adaptation. For example, the WTRU 102 may select a RO (e.g., only if) if the WTRU 102 has used an alternative threshold for selecting an associated SSB in the RACH procedure.

In certain embodiments, a WTRU 102 may add an offset to the PRACH transmission power if the WTRU 102 transmits a PRACH towards a cell with SSB power adaptation, if the WTRU 102 has selected an SSB with power reduction, and/or the WTRU 102 has selected an SSB using a non-default channel condition threshold. The WTRU 102 may determine the offset to add to the transmit power as a function of the SSB transmit power reduction.

For example, the WTRU 102 may determine the PRACH transmission power as the function below:

$$PRACH transmit power = {P}_{0 , PRACH} + offset ;$$

where P_{0,PRACH} is a nominal transmit power (e.g., for PRACH) offset=default RSRP selection threshold-selected SSB RSRP selection threshold; or the offset=indicated SSB power reduction (e.g., in SI).

In certain embodiments, a WTRU 102 may scale or add an offset to the preamble power ramping step, such as where the offset or scaling is proportional to the SSB power reduction and/or the retransmission number.

### Radio Link and Beam Management During SSB/RS Transmission Power Adaptation

In certain representative embodiments, during SSB/RS beam power adaption, a WTRU 102 may determine to update and/or change a set of one or more source SSB/RS beams, that may be configured as RLM-RS for supporting radio link maintenance/monitoring (RLM) and radio link failure detection/recovery procedures, with another set of target SSB/RS beams. For example, the source SSB/RS beams may be subject to power adaptation (e.g., changes in transmit power), upon receiving an associated indication. The target SSB/RS beams may be associated with the set of source SSB/RS beams based on similar QCL properties (e.g., similar antenna ports, elements, and/or panels used for transmission or similar channel properties) and/or configured from a similar pool of resources (e.g., associated with common or similar TCI pool). The WTRU 102 may determine to change the source SSB/RS beams that are used as RLM-RS with the target SSB/RS beams based on an indication received from the network and/or measurements made on the source and/or target SSB/RS beams (e.g., before and/or after receiving the indication). Similar configuration properties may apply in cases where a set of SSB/RS beams that may be subject to power adaption may be configured as BM-RS for supporting beam maintenance/management and beam failure detection/recovery procedures. In the following, the terms related to RLM and BM may be used interchangeably and any of the associated configurations, indications and procedures may be applicable for both, unless any apparent differences are indicated. Any of the configurations, parameters, and embodiments described herein may be applicable.

In certain representative embodiments, a WTRU 102 may be configured with a set of SSB/RS beams and one or more parameters associated with RLM and/or BM.

For example, a WTRU 102 may receive configuration information from the network as described herein. The configuration information may be associated with one or more source and target SSB/RS beams, such as for RLM and/or RLF. Such configuration information may be received, entirely or in one or more parts, in any of L3 (e.g., RRC signalling), L2 (e.g., MAC signaling, such as MAC CE) and/or L1 (e.g., PDCCH, such as DCI) indications. The configuration information may include any (e.g., combination) of the following: a set of RS beams (e.g., RLM-RS); one or more parameters associated with RLM; and/or an application or delay time.

For example, a WTRU 102 may be configured with a set of RS beams for RLM (RLM-RS). The WTRU 102 may be configured with one or more SSB/RS beams that may be grouped into one or more sets of RS beams and/or may be associated with at least one common property and/or characteristic. For example, when any property and/or association for at least one of the SSB/RS beam in a set is changed or adapted, a similar change or adaptation may apply for at least a subset of the other SSB/RS beams in the set. As an example, when configured with a power adaptation pattern (e.g., transmit power of SSB beam changes in each burst), the set of SSB/RS beams configured as RLM-RS may change across different periods. As an example, a set of one or more SSB/RS beams may be configured as RLM-RS (e.g., as a QCL source for RLM), a subset of which may be used as source RLM-RS and another subset may be used as target RLM-RS. In such cases, during beam power adaptation, the source RLM-RS may be replaced by the target RLM-RS beams, such as when one or more measurement conditions associated with replacing the source RLM-RS with the target RLM-RS beams are met. As another example, the set of SSB/RS beams in the target RLM-RS that may replace the RS beams in the source RLM-RS may be associated with a common TCI pool.

For example, a WTRU 102 may be configured with one or more (e.g., a set of) parameters associated with RLM. A WTRU 102 may be configured with any of the following set of parameters: a RLM-RS monitoring periodicity (e.g., periodicity at which the WTRU 102 may perform measurements of RLM-RS), a maximum and/or minimum count associated with radio link failure (e.g., a N1 value), a maximum and/or minimum count associated with radio link recovery (e.g., a N2 value), maximum and/or minimum time duration associated with RLM (e.g., a T1 value), a maximum and/or minimum time duration associated with radio link recovery (e.g., a T2 value). For example, a N1 value may be referred to as “NQout” and a N2 value may be referred to as “NQin”. Such N1 and N2 values may be related to the max counts for meeting BLER targets for hypothetical reception of signals and/or channels from the network (e.g., PDCCH) when using the RLM-RS as the QCL source. The T2 value may be associated with (e.g., configure) a T310 timer, for example.

For example, the WTRU 102 may be configured with association information that may indicate the association between the parameter values for RLM {N1, N2, T1, T2} and the power parameters (e.g., peak power, power offset values, power adaptation pattern). For example, the WTRU 102 may use a first set of RLM/BM parameters when a first power pattern (e.g., uniform power for all active SSBs in a burst) is indicated and switch to using a second set of RLM/BM parameters when a second pattern (e.g., non-uniform power for SSBs in a burst) is indicated. Such sets of parameters may be applied for the same or different sets of SSB/RS beams, such as may be configured as source or target RLM/RS/BM-RS.

The set of parameters for RLM may be associated with the set of SSB/RS beams used as RLM-RS. The set of RLM parameters may be the same or different for the different sets of SSB/RS beams used as the source RLM-RS and the target RLM-RS (e.g., the source RLM-RS and target RLM-RS may use different sets of values for {N1, N2, T1, T2}).

For example, when configured for beam failure monitoring/recovery, the WTRU 102 may be configured with a set of parameters including a maximum and/or minimum count associated with beam failure detection (e.g., a M1 value), a maximum and/or minimum count associated with beam failure recovery (e.g., a M2 value), and/or a maximum and/or minimum time duration associated with beam recovery (e.g., a T3 value). The parameters for beam failure may be the same or different than those used for RLM, for example.

For example, the WTRU 102 may be configured with an application time and/or delay. The WTRU 102 may be configured with one or more application time and/or delay values, which may indicate a time duration starting with a time instance (e.g., symbol and/or slot) from the reception of an indication indicating power adaptation associated with any SSB/RS beams configured as RLM-RS and/or BM-RS. As another example, the application time and/or delay may indicate a time duration starting with a time instance from the reception of an indication indicating the availability of target RS beams (e.g., with power adaptation) to the time instance when the target RS beams are actually available.

For example, after receiving configuration information and/or indication(s) of one or more RS beams as source RLM-RS, the WTRU 102 may perform monitoring of the RS beams according to the parameters associated with RLM.

In certain representative embodiments, a WTRU 102 may perform a radio link failure (RLF) detection procedure during SSB/RS power adaptation.

For example, the WTRU 102 may receive an indication from the network associated with power adaptation and/or switching of RS beams from a set of source SSB/RS beams to a set of target SSB/RS beams, such as for RLM/BM. Such an indication may be received in any of in any of L3 (e.g., RRC signalling), L2 (e.g., MAC signaling, such as MAC CE) and/or L1 (e.g., PDCCH, such as DCI) indications, for example. Such indications may indicate any of the signaling, information, and/or parameters described herein. For example, the indication may indicate the set of target RS beams that may replace the set of source RLM-RS beams or replace a first set of parameters and/or thresholds with a second set of parameters and/or thresholds for the same set of SSB/RS beams. In the following ‘replacing a source RLM-RS with a target RLM-RS’ may refer to ‘changing from a first set of parameters to a second set of parameters’, where the parameters may be associated with any of power adaptation parameters and RLM-RS/BM-RS parameters and/or thresholds. In such cases, when using the first set of parameters, the set of SSB/RS beams may correspond to a source RLM-RS/BM-RS and when using the second set of parameters the set of SSB/RS beams may correspond to a target RLM-RS/BM-RS.

The WTRU 102 may determine a first set of one or more target RLM-RSs, such as for replacing the set of source RLM-RS beams, based on the received power adaptation indication and the configured set of parameters for RLM. For example, the WTRU 102 may determine a first set of target RLM-RS from an active set of target SSB/RS beams that correspond to any of the following: (i) transmitted with a transmit power that is within a range (e.g., upon applying power offset and/or adjustment); (ii) has a start time (e.g., a first symbol of a first target RS beam with power adaptation in a burst and/or window) that is no later than a threshold value; and/or (iii) has an end time (e.g., a last symbol of a last target RS beam with power adaptation in a burst and/or window) that is within the time duration associated with the T1 and/or N1 parameters.

The WTRU 102 may perform RLM measurements (e.g., any of L3, L2, L1 measurements of EPRE, RSRP, RSSI, and/or RSRQ) on the one or more SSB/RS beams that are selected or determined as a first set of target RLM-RS. In the case when the existing source RLM-RS beams are still transmitted with existing power parameters (e.g., without power adaptation) when the WTRU 102 determines the first set of target RLM-RS beams, the WTRU 102 may perform any of the following: (i) continue performing measurements on the source RLM-RS beams, such as along with measurements of the first target RLM-RS beams (e.g., in the symbols, slots, or other occasions when the RS beams are received) and/or (ii) stop or suspend performing measurements on source RLM-RS beams. The WTRU 102 may send an indication to the network indicating any of the stopping of RLM measurements on the source RLM-RS, a report on the measurements made on the source RLM-RS (e.g., up to a stopping time instance) and/or a confirmation indication on switching to the target RLM-RS (e.g. indexes or other identifiers of target RLM-RS beams and/or an index or other identifier of the set of target RLM-RS).

For example, when any link failure conditions (e.g., RSRP is less than a threshold value, where the threshold may be associated with the adjusted per SSB/RS beam threshold) are detected during RLM measurements on the first target RLM-RS beams, the WTRU 102 may increment a link failure counter at each RLM measurement instance. When making RLM measurements on the source RLM-RS and when the link failure counter is incremented to a certain (e.g., configured or predefined) “n1” value, the WTRU 102 may continue the count “x” in the counter when switching to the first target RLM-RS and making RLM measurements (e.g., counter=n1+x).

As another example, when switching to the first target RLM-RS, the WTRU 102 may reset the link failure counter (e.g., counter=0) and apply a new count value when making RLM measurements. Such resetting of the link failure counter during RS beam switching may be conditional on any of the following: (i) a change in transmit power is within a threshold range, (ii) a QCL/TCI pool in which the source and target RLM-RSs belong to, (iii) the time duration for switching between source and target RLM-RS, (iv) mobility of the WTRU 102, (v) a value of n1 prior to RS switching, and/or other conditions. For example, when the source RLM-RS and the target RLM-RS belong to different TCI pools or have different QCL properties, the WTRU 102 may reset the link failure counter. Otherwise, if both source and target RLM-RSs have the same QCL properties (e.g., no change in QCL type), the WTRU 102 may continue the count value in the counter when switching.

In an example, when detecting a link failure event (e.g., a number of consecutive link failure counts is greater than or equal to N1), the WTRU 102 may determine a second set of one or more target RLM-RS beams, such as from the set of target RS beams for replacing the set of first set of target RLM-RS beams. For example, the WTRU 102 may determine a second set of target RLM-RS from the active target SSB/RS beams that correspond to any of the following: (i) transmitted with a transmit power that is within a range (e.g., upon applying power offset and/or adjustment), (ii) has a start time (e.g., first RS beam in a burst) that is no later than a threshold value, and/or (iii) has an end time (e.g., last RS beam in a burst) that is within the time duration associated with the T2 and/or N2 parameters. The WTRU 102 may send an indication to the network, such as indicating any of the detection of a link failure event (e.g., when using the first target RLM-RS), the measurements made on the first target RLM-RS, and/or the selection of the second target RLM-RS. As another example, if there are no active target RLM-RS that meet the selection criteria associated with the RLM parameters (e.g., T2, N2), the WTRU 102 may send an indication to request for new set of SSB/RS beams that may be used as the second target RLM-RS.

In certain representative embodiments, a WTRU 102 may perform a radio link recovery procedure during SSB/RS power adaptation.

For example, the selected and/or determined second set of target RLM-RS beams may be used for a link failure recovery procedure. The WTRU 102 may perform measurements (e.g., any of L3, L2, and/or L1 measurements) on the one or more SSB/RS beams determined as the second target RLM-RS. When any link recovery conditions (e.g., RSRP is greater than a threshold value, where the threshold may be associated with the adjusted per SSB/RS beam threshold) are detected during RLM measurements on the second target RLM-RS beams, the WTRU 102 may increment a link recovery counter at each RLM measurement instance. The WTRU 102 may start a timer associated (e.g., configured) with the T2 value when triggering the link recovery procedure (e.g., when detecting the first link recovery count or when switching to the second target RLM-RS). As another example, the WTRU 102 may have triggered a link recovery procedure (e.g., incrementing the link recovery counter to “n2” and/or started the T2 timer) during measurements on the first target RLM-RS. In this case, when receiving an indication on power adaptation, the WTRU 102 may determine a second set of target SSB/RS beams and may continue the count “y” in the link recovery counter when making measurements on the second target RLM-RS (e.g., counter=n2+y).

As another example, when switching to the second target RLM-RS, the WTRU 102 may reset the link recovery counter (e.g., counter=0) and/or the T2 timer. In this case, the WTRU 102 may apply new count value and/or restart the T2 timer when making RLM measurements for link recovery. Such resetting of the link recovery counter may be conditional on any of the same or similar conditions associated with link failure, such as described above.

For example, when detecting a link recovery event (e.g., a number of consecutive link recovery counts are greater than or equal to N2 and/or the T2 timer has not expired), the WTRU 102 may reset the T2 timer and/or N2 counter and/or may send an RLM report to the network, indicating any of the measurements (e.g., L3, L1 RSRP measurements) made on the first and/or second target RLM-RS, indexes or other identifiers of the target SSB/RS beams in the first and/or second set of target RLM-RS, and/or the count values for link failure and recovery. In the case when link recovery is not possible (e.g., the T2 timer expires and/or the number of consecutive link recovery counts are less than N2), the WTRU 102 may send an indication to request for a new set of RS beams for RLM or send a PRACH preamble (e.g., using CBRA or CFRA PRACH resources for triggering RRC connection re-establishment). The examples described for link failure detection and link recovery using source and target RLM-RS beams may also be applied for beam failure detection and beam recovery procedures, such as by using the set of configured parameters (e.g. M1, M2, T3) associated with beam management.

### Example Solutions

In certain representative embodiments, a WTRU 102 may determine a per-beam transmit power level and timing information of SSB bursts (e.g., for measurements and best beam selection for PRACH transmission) based on semi-static and dynamic indications received on the SSB parameters. The WTRU 102 may detect a cell based on reception of at least one SSB. For example, cell detection may include performing (e.g., time and/or frequency) synchronization based on the received PSS and/or SSS associated with the at least one SSB. The WTRU 102 may receive an indication of one or more semi-static SSB parameters in a MIB (e.g., PBCH payload). The semi-static SSB parameters may include at least the peak SSB power (e.g., transmit power of a reference SSB). For example, other semi-static SSB parameters may include any of SSB time domain location parameters (e.g., SFN index, half-frame index, SSB burst periodicity) and SSB positions in a burst. For example, the WTRU 102 may receive (e.g., in the MIB) information on any CORESET and/or any SS for receiving a PDCCH (e.g., a multiplexing pattern). The WTRU 102 may receive an indication of one or more dynamic SSB parameters in a PDCCH transmission. For example, the dynamic SSB parameters may be received in a group common DCI in a CORESET and/or SS indicated by the MIB. For example, the dynamic SSB parameters may include any of a SSB power pattern (e.g., indexes), a start offset of the power pattern, a periodicity of the power pattern, and/or a power offset per SSB. Other dynamic parameters may include a reference SSB per burst and/or a RSRP threshold per SSB. The WTRU 102 may determine one or more SSB bursts (e.g., for measurements) based on the transmit power of SSBs and the association between the transmit power and time domain locations of the SSBs. For example, the WTRU 102 may determine the transmit power of each active SSB in a burst based on the peak SSB power and power offset per SSB parameters. For example, the WTRU 102 may determine the association between the transmit power and time domain locations of SSBs based on SSB power pattern parameters (e.g., index of SSB power pattern, start offset of pattern, and/or periodicity of pattern) and SSB time domain location parameters (e.g., SFN index, half-frame index, and/or SSB burst periodicity). For example, the WTRU 102 may determine a subset of SSB bursts from a set (e.g., in a period) for measurements only when some target SSB(s) within a burst are transmitted with peak power. The WTRU 102 may perform measurements of the SSBs in one or more of the determined bursts. The WTRU 102 may determine a best SSB among the measured SSBs based on the received parameters and measurements. For example, the WTRU 102 may determine the best SSB from the measured SSBs with RSRPs that are above the RSRP threshold per SSB. If the RSRPs of all SSBs are below their thresholds, the WTRU 102 may determine the best SSB from the SSB with a lowest pathloss estimation. For example, one or more criteria for beam ranking and selecting the best SSB among the measured SSBs may be based on a combination of RSRP measurements and pathloss estimation. The WTRU 102 may transmit a PRACH with a transmit power in a beam that is associated with the best SSB. For example, the WTRU 102 may determine the transmit power for PRACH based on the pathloss estimation made on the best SSB.

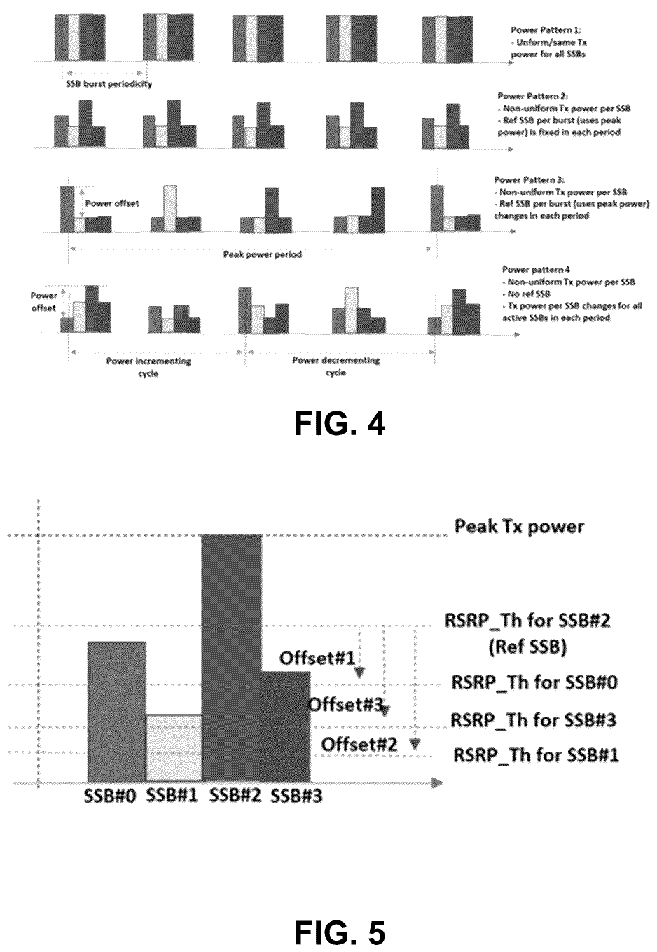

FIG. 6 is a procedural diagram illustrating an example procedure for determining SSBs during transmit power adaptation, according to one or more embodiments of the present disclosure. In FIG. 6, a WTRU 102 may be configured to detect a cell based on reception of one or more SSBs at 602. At 604, the WTRU 102 may receive a MIB from the one or more SSBs. The MIB may include information indicating a first set of SSB parameters. For example, the first set of SSB parameters may include a peak transmit power of a reference SSB. At 606, the WTRU 102 may receive a PDCCH transmission including information indicating a second set of SSB parameters. At 608, the WTRU 102 may determine a set of SSB bursts based on the first set of SSB parameters, the second set of SSB parameters, and time domain locations of SSBs of the set of SSB bursts. At 610, the WTRU 102 may measure one or more SSBs in the determined set of SSB bursts. At 612, the WTRU 102 may send a PRACH transmission (e.g., Msg1 or MsgA) using a transmit power and/or a beam that is associated with an SSB of the measured one or more SSBs.

In some embodiments, the first set of SSB parameters may include any of a sub-frame number index, a half-frame index, a SSB burst periodicity, and/or SSB positions in a SSB burst.

In some embodiments, the second set of SSB parameters may include any of a SSB power pattern, a start of the SSB power pattern, a periodicity of the SSB power pattern, and/or a power offset.

In some embodiments, the WTRU 102 may be configured to determine a respective transmit power for each of the SSBs of the set of SSB bursts based on the peak transmit power, the SSB power pattern, and the power offset.

In some embodiments, the WTRU 102 may be configured to determine an association between the respective transmit power for each of the SSBs of the set of SSB bursts and the time domain locations of the SSBs of the set of SSB bursts based on the first set of SSB parameters and the second set of SSB parameters.

In some embodiments, the WTRU 102 may be configured to determine the set of SSB bursts as SSB bursts which each include the reference SSB.

In some embodiments, the WTRU 102 may be configured to receive the PDCCH transmission using a CORESET and/or a SS. For example, the MIB may include information indicating the CORESET and/or the SS.

In some embodiments, the PDCCH transmission may include group common DCI. For example, the group common DCI may include the information indicating the second set of SSB parameters.

In some embodiments, the WTRU 102 may be configured to determine the SSB, as a best SSB, of the measured one or more SSBs based on a comparison of respective RSRPs of the measured one or more SSBs and a (e.g., respective) RSRP threshold per SSB. For example, the second set of SSB parameters may include the respective RSRP threshold(s) per SSB.

In some embodiments, the WTRU 102 may be configured to determine the SSB, as a best SSB, of the measured one or more SSBs based on a comparison of respective pathloss estimates of the measured one or more SSBs.

In some embodiments, the WTRU 102 may be configured to determine the transmit power used for the PRACH transmission based on a pathloss estimate associated with the (e.g., best) SSB of the measured one or more SSBs, such as by using the first and second sets of SSB parameters.

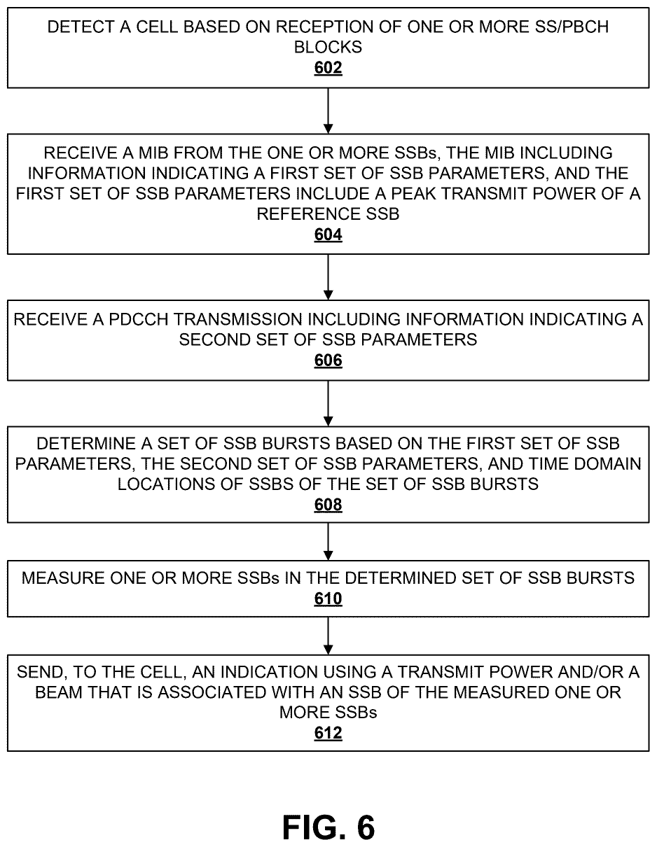

FIG. 7 is a procedural diagram illustrating an example procedure for determining a SSB power pattern, according to one or more embodiments of the present disclosure. As shown in FIG. 7, a WTRU 102 may receive information indicating a set of parameters associated with SSB transmit power adaptation at 702. At 704, the WTRU 102 may receive one or more indications associated with the SSB transmit power adaptation. At 706, the WTRU 102 may determine a SSB power pattern for a set of SSB bursts associated with the SSB transmit power adaptation. At 708, the WTRU 102 may measure one or more SSBs in the determined set of SSB bursts. At 710, the WTRU 102 may send a transmission (e.g., PRACH transmission or other indication) based on measurement information associated with the measured one or more SSBs satisfying one or more conditions.

In some embodiments, each SSB burst of the determined set of SSB bursts may include a reference SSB which is transmitted with a peak transmit power.

In some embodiments, each SSB burst of the determined set of SSB bursts may include one or more SSBs which are transmitted with a respective transmit power(s) which is offset and/or adapted from the peak transmit power.

In some embodiments, the SSB power pattern may indicate respective time domain locations of one or more reference SSBs and one or more other SSBs in the determined set of SSB bursts.

In some embodiments, the WTRU 102 may be configured to determine the set of SSB bursts from a plurality of SSB bursts. For example, the plurality of SSB bursts may include one or more SSB bursts which are not associated with the SSB transmit power adaptation.

In some embodiments, the WTRU 102 may be configured to determine a best SSB from the measured one or more SSBs based on the measurement information associated with the measured one or more SSBs satisfying the one or more conditions.

In some embodiments, the transmission may include reporting information (e.g., a report) indicating at least part of the measurement information associated with the measured one or more SSBs.

In some embodiments, the transmission may be a PRACH transmission (e.g., Msg1 or MsgA or another indication) that is sent using a transmit power and/or a beam that is determined based on the measurement information associated with an SSB of the measured one or more SSBs.

In some embodiments, the transmit power used for the PRACH transmission may be determined using a nominal transmit power (e.g., P₀) and an offset. For example, and the offset may be based on the measurement information associated with the SSB of the measured one or more SSBs.

In some embodiments, the WTRU 102 may receive information indicating a NES state. For example, the indicated NES state may be associated with the SSB transmit power adaptation.

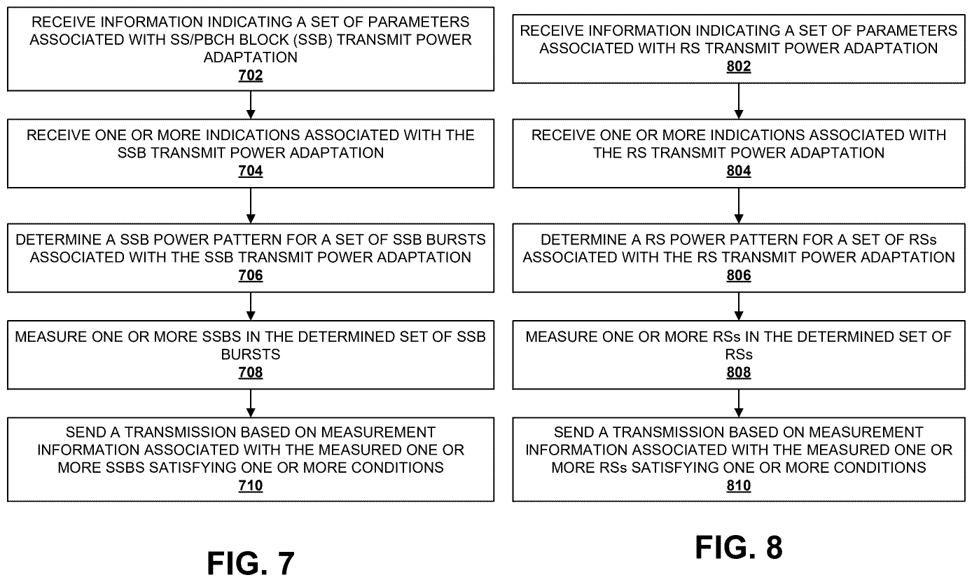

FIG. 8 is a procedural diagram illustrating an example procedure for determining a RS power pattern, according to one or more embodiments of the present disclosure. As shown in FIG. 8, a WTRU 102 may receive information indicating a set of parameters associated with RS transmit power adaptation at 802. At 804, the WTRU 102 may receive one or more indications associated with the RS transmit power adaptation. At 806, the WTRU 102 may determine a RS power pattern for a set of RSs associated with the RS transmit power adaptation. At 808, the WTRU 102 may measure one or more RSs in the determined set of RSs. At 810, the WTRU 102 may send a transmission (e.g., PRACH transmission or other indication) based on measurement information associated with the measured one or more RSs satisfying one or more conditions.

In some embodiments, each RS of the determined set of RSs may include a reference RS which is transmitted with a peak transmit power.

In some embodiments, each RS of the determined set of RSs may include one or more RSs which are transmitted with a respective transmit power(s) which is offset and/or adapted from the peak transmit power.

In some embodiments, the SRSSB power pattern may indicate respective time domain locations of one or more reference RSs and one or more other RSs in the determined set of RSs.

In some embodiments, the WTRU 102 may be configured to determine the set of RSs from a plurality of RSs. For example, the plurality of RSs may include one or more RSs which are not associated with the RS transmit power adaptation.

In some embodiments, the WTRU 102 may be configured to determine a best RS from the measured one or more RSs based on the measurement information associated with the measured one or more RSs satisfying the one or more conditions.

In some embodiments, the transmission may include reporting information (e.g., a report) indicating at least part of the measurement information associated with the measured one or more RSs.

In some embodiments, the transmission may be a PRACH transmission (e.g., Msg1 or MsgA or another indication) that is sent using a transmit power and/or a beam that is determined based on the measurement information associated with an RS of the measured one or more RSs.

In some embodiments, the transmit power used for the PRACH transmission may be determined using a nominal transmit power (e.g., P₀) and an offset. For example, and the offset may be based on the measurement information associated with the RS of the measured one or more SSBs.

In some embodiments, the WTRU 102 may receive information indicating a NES state. For example, the indicated NES state may be associated with the RS transmit power adaptation.

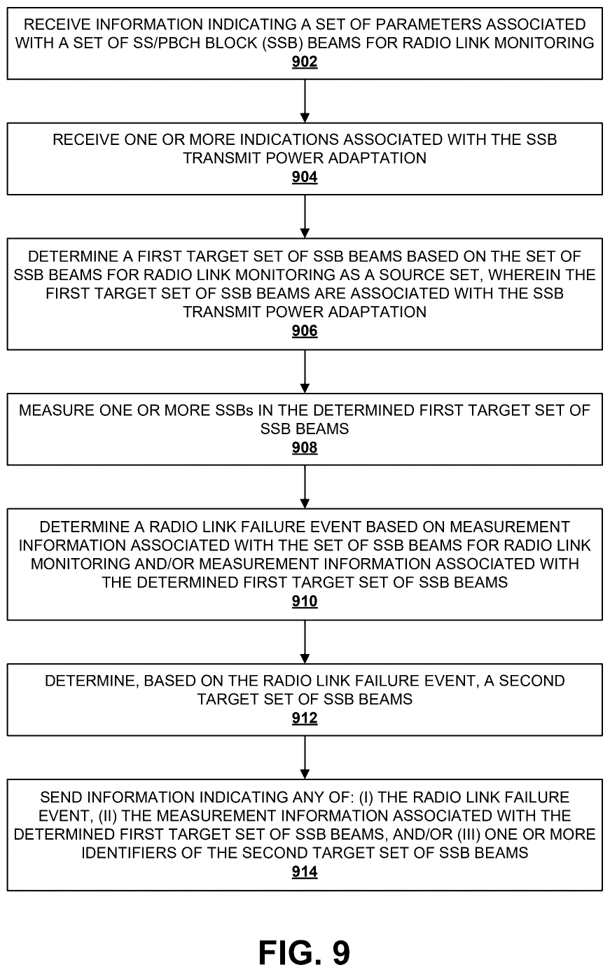

FIG. 9 is a procedural diagram illustrating an example procedure for radio link management during SSB transmit power adaptation, according to one or more embodiments of the present disclosure. As shown in FIG. 9, a WTRU 102 may be configured to receive information indicating a set of parameters associated with a set of SSB beams for radio link monitoring at 902. At 904, the WTRU 102 may receive one or more indications associated with the SSB transmit power adaptation. At 906, the WTRU 102 may determine a first target set of SSB beams based on the set of SSB beams for radio link monitoring as a source set. For example, the first target set of SSB beams may be associated with the SSB transmit power adaptation. At 908, the WTRU 102 may measure one or more SSBs in the determined first target set of SSB beams. At 910, the WTRU 102 may determine a radio link failure event based on measurement information associated with the set of SSB beams for radio link monitoring and/or measurement information associated with the determined first target set of SSB beams. At 912, the WTRU 102 may determine, based on the radio link failure event, a second target set of SSB beams. At 914, the WTRU 102 may send information indicating any of: (i) the radio link failure event, (ii) the measurement information associated with the determined first target set of SSB beams, and/or (iii) one or more identifiers of the second target set of SSB beams.

In some embodiments, the WTRU 102 may be configured to receive configuration information indicating a set of parameters associated with (e.g., a configuration of) the first target set of SSB beams.

In some embodiments, the one or more indications associated with the SSB transmit power adaptation may include information indicating a set of parameters associated with the first target set of SSB beams.

In some embodiments, the WTRU 102 may be configured to determine the first target set of SSB beams based on one or more quasi-colocated (QCL) properties of the set of SSB beams for radio link monitoring and/or a resource pool associated with the set of SSB beams for radio link monitoring.

In some embodiments, the WTRU 102 may be configured to measure one or more SSBs in the set of SSB beams for radio link monitoring.

In some embodiments, the measurement information associated with the determined first target set of SSB beams may include any of an energy per resource element (EPRE), a reference signal received power (RSRP), a reference signal strength indicator (RSSI), and/or a reference signal received quality (RSRQ).

In some embodiments, the measurement information associated with the set of SSB beams for radio link monitoring may include any of an EPRE, a RSRP, a RSSI, and/or a RSRQ.

In some embodiments, the first target set of SSB beams and the second target set of SSB beams may be determined from an active target set of SSB beams.

In some embodiments, the WTRU 102 may be configured to determine a radio link recovery event based on measurement information associated with the determined first target set of SSB beams and/or measurement information associated with the determined second target set of SSB beams.

In some embodiments, the WTRU 102 may be configured to send information indicating any of: (i) the radio link recovery event, (ii) the measurement information associated with the determined first target set of SSB beams, (iii) the measurement information associated with the determined second target set of SSB beams, (iv) one or more identifiers of determined first target set of SSB beams, and/or (v) one or more identifiers of determined second target set of SSB beams.

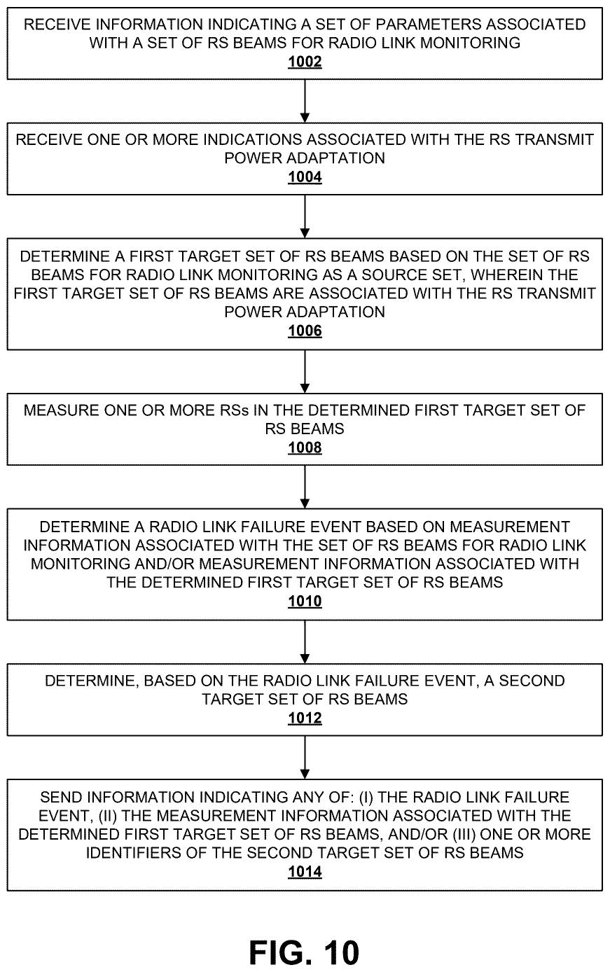

FIG. 10 is a procedural diagram illustrating an example procedure for radio link management during RS transmit power adaptation, according to one or more embodiments of the present disclosure. As shown in FIG. 10, a WTRU 102 may be configured to receive information indicating a set of parameters associated with a set of RS beams for radio link monitoring at 1002. At 1004, the WTRU 102 may receive one or more indications associated with the RS transmit power adaptation. At 1006, the WTRU 102 may determine a first target set of RS beams based on the set of SSRSB beams for radio link monitoring as a source set. For example, the first target set of RSSSB beams may be associated with the RS transmit power adaptation. At 1008, the WTRU 102 may measure one or more RSs in the determined first target set of RS beams. At 1010, the WTRU 102 may determine a radio link failure event based on measurement information associated with the set of RS beams for radio link monitoring and/or measurement information associated with the determined first target set of RS beams. At 1012, the WTRU 102 may determine, based on the radio link failure event, a second target set of RS beams. At 1014, the WTRU 102 may send information indicating any of: (i) the radio link failure event, (ii) the measurement information associated with the determined first target set of RS beams, and/or (iii) one or more identifiers of the second target set of RS beams.

In some embodiments, the WTRU 102 may be configured to receive configuration information indicating a set of parameters associated with (e.g., a configuration of) the first target set of RS beams.

In some embodiments, the one or more indications associated with the RS transmit power adaptation may include information indicating a set of parameters associated with the first target set of RS beams.

In some embodiments, the WTRU 102 may be configured to determine the first target set of RS beams based on one or more quasi-colocated (QCL) properties of the set of RS beams for radio link monitoring and/or a resource pool associated with the set of RS beams for radio link monitoring.

In some embodiments, the WTRU 102 may be configured to measure one or more RSs in the set of RS beams for radio link monitoring.

In some embodiments, the measurement information associated with the determined first target set of RS beams may include any of an energy per resource element (EPRE), a reference signal received power (RSRP), a reference signal strength indicator (RSSI), and/or a reference signal received quality (RSRQ).

In some embodiments, the measurement information associated with the set of RS beams for radio link monitoring may include any of an EPRE, a RSRP, a RSSI, and/or a RSRQ.

In some embodiments, the first target set of RS beams and the second target set of RS beams may be determined from an active target set of RS beams.

In some embodiments, the WTRU 102 may be configured to determine a radio link recovery event based on measurement information associated with the determined first target set of RS beams and/or measurement information associated with the determined second target set of RS beams.

In some embodiments, the WTRU 102 may be configured to send information indicating any of: (i) the radio link recovery event, (ii) the measurement information associated with the determined first target set of RS beams, (iii) the measurement information associated with the determined second target set of RS beams, (iv) one or more identifiers of determined first target set of RS beams, and/or (v) one or more identifiers of determined second target set of RS beams.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A wireless transmit/receive unit (WTRU) comprising:
a transceiver, memory, and a processor which are configured to:
detect a cell based on reception of one or more synchronization signal/physical broadcast channel (SS/PBCH) blocks (SSBs),
receive a master information block (MIB) from the one or more SSBs, the MIB including information indicating a first set of SSB parameters,
receive a physical downlink control channel (PDCCH) transmission including information indicating a second set of SSB parameters,
determine a set of SSB bursts based on the first set of SSB parameters, the second set of SSB parameters, and time domain locations of SSBs of the set of SSB bursts,
measure one or more SSBs in the determined set of SSB bursts, and
send, to the cell, an indication using a transmit power and/or a beam that is associated with an SSB of the measured one or more SSBs.

2. The WTRU of claim 1, wherein the first set of SSB parameters include any of a peak transmit power of a reference SSB, a sub-frame number index, a half-frame index, a SSB burst periodicity, and/or SSB positions in a SSB burst.

3. The WTRU of claim 1, wherein the second set of SSB parameters including any of a SSB power pattern, a start of the SSB power pattern, a periodicity of the SSB power pattern, and/or a power offset.

4. The WTRU of claim 3, wherein the transceiver, the memory, and the processor are configured to determine a respective transmit power for each of the SSBs of the set of SSB bursts based on the peak transmit power, the SSB power pattern, and the power offset.

5. The WTRU of claim 1, wherein the transceiver, the memory, and the processor are configured to determine an association between the respective transmit power for each of the SSBs of the set of SSB bursts and the time domain locations of the SSBs of the set of SSB bursts based on the first set of SSB parameters and the second set of SSB parameters.

6. The WTRU of claim 1, wherein the transceiver, the memory, and the processor are configured to determine the set of SSB bursts as SSB bursts which each include a reference SSB.

7. The WTRU of claim 1, wherein the transceiver, the memory, and the processor are configured to receive the PDCCH transmission using a control resource set (CORESET) and/or a search space (SS), wherein the MIB includes information indicating the CORESET and/or the SS.

8. The WTRU of claim 1, wherein the PDCCH transmission includes group common downlink control information (DCI), and the group common DCI includes the information indicating the second set of SSB parameters.

9. The WTRU of claim 1, wherein the transceiver, the memory, and the processor are configured to determine the SSB, as a best SSB, of the measured one or more SSBs based on a comparison of a respective reference signal received power (RSRP) of the measured one or more SSBs and a RSRP threshold per SSB and/or a comparison of respective pathloss estimates of the measured one or more SSBs,
wherein the second set of SSB parameters include the RSRP threshold per SSB.

10. (canceled)

11. The WTRU of claim 1, wherein the indication comprises a physical random access channel (PRACH) transmission, and wherein the transceiver, the memory, and the processor are configured to determine the transmit power used for the PRACH transmission based on a pathloss estimate associated with the SSB of the measured one or more SSBs.

12. (canceled)

13. A method implemented by a wireless transmit/receive unit (WTRU), the method comprising:
detecting a cell based on reception of one or more synchronization signal/physical broadcast channel (SS/PBCH) blocks (SSBs);
receiving a master information block (MIB) from the one or more SSBs, the MIB including information indicating a first set of SSB parameters;
receiving a physical downlink control channel (PDCCH) transmission including information indicating a second set of SSB parameters;
determining a set of SSB bursts based on the first set of SSB parameters, the second set of SSB parameters, and time domain locations of SSBs of the set of SSB bursts;
measuring one or more SSBs in the determined set of SSB bursts; and
sending, to the cell, an indication using a transmit power and/or a beam that is associated with an SSB of the measured one or more SSBs.

14. The method of claim 13, wherein the first set of SSB parameters include any of a peak transmit power of a reference SSB, a sub-frame number index, a half-frame index, a SSB burst periodicity, and/or SSB positions in a SSB burst.

15. The method of claim 13, wherein the second set of SSB parameters including any of a SSB power pattern, a start of the SSB power pattern, a periodicity of the SSB power pattern, and/or a power offset.

16. The method of claim 15, further comprising:
determining a respective transmit power for each of the SSBs of the set of SSB bursts based on the peak transmit power, the SSB power pattern, and the power offset.

17. The method of claim 13, further comprising:
determining an association between the respective transmit power for each of the SSBs of the set of SSB bursts and the time domain locations of the SSBs of the set of SSB bursts based on the first set of SSB parameters and the second set of SSB parameters.

18. The method of claim 13, further comprising:
determining the set of SSB bursts as SSB bursts which each include a reference SSB.

19. The method of claim 13, wherein the PDCCH transmission is received using a control resource set (CORESET) and/or a search space (SS),
wherein the MIB includes information indicating the CORESET and/or the SS.

20. The method of claim 13, wherein the PDCCH transmission includes group common downlink control information (DCI), and the group common DCI includes the information indicating the second set of SSB parameters.

21. The method of claim 13, further comprising:
determining the SSB, as a best SSB, of the measured one or more SSBs based on a comparison of a respective reference signal received power (RSRP) of the measured one or more SSBs and a RSRP threshold per SSB and/or a comparison of respective pathloss estimates of the measured one or more SSBs,
wherein the second set of SSB parameters include the RSRP threshold per SSB.

22. (canceled)

23. The method of claim 13, wherein the indication comprises a physical random access channel (PRACH) transmission, and
wherein the transmit power used for the PRACH transmission is determined based on a pathloss estimate associated with the SSB of the measured one or more SSBs.

24. (canceled)
